(19) United States
(12) Patent Application Publication
(10) Pub. No.: US 2026/0221472 A1
(43) Pub. Date: Jul. 30, 2026

(54) FUEL CELL SYSTEM WITH LIQUID ORGANIC HYDROGEN CARRIER SYSTEM

(71) Applicant: Honeywell International Inc., Charlotte, NC (US)

(72) Inventors: Saugata Chakravorty, Kolkata (IN); Sreeja Surendran, Bangalore (IN)

(21) Appl. No.: 19/088,624

(22) Filed: Mar. 24, 2025

(30) Foreign Application Priority Data
Jan. 24, 2025 (IN) 202511006190

(51) Int. Cl. H01M 8/04007; H01M 8/04014; H01M 8/04029; H01M 8/04082

(52) U.S. Cl. CPC H01M 8/04059; H01M 8/04014; H01M 8/04029; H01M 8/04216; H01M 2250/20

(57) ABSTRACT

A system comprising a fuel cell, a coolant circuit, and a dehydrogenation reactor for a liquid organic hydrogen carrier (LOHC). The fuel cell has an operating temperature about, or less than, an operating temperature of the dehydrogenation reactor. The coolant circuit is configured to circulate a coolant from a heat-exchanger of the fuel cell through a temperature lift stage to a heat-exchanger of the dehydrogenation reactor. The temperature lift stage of the coolant circuit is configured to raise the temperature of the coolant. A hydrogen-rich LOHC (LOHC_{Rich}) is passed through a pre-heating stage prior to the dehydrogenation reactor. The system is configured to transfer heat from the coolant in the temperature lift stage of the coolant circuit to the LOHC_{Rich} in the LOHC pre-heating stage.

### BACKGROUND

Hydrogen fuel cells are an emerging technology with potential applications across virtually all sectors of industry. Hydrogen offers a fuel that has a high gravimetric energy density and provides only water as a byproduct of oxidation. However, significant challenges remain for widespread adoption of hydrogen fuel.

One significant challenge is the hydrogen has a low volumetric density, which can implicate large or heavy storage systems. These storage methods present issues related to cost, weight, and safety, making them less practical for many applications. Another challenge is the thermal management of fuel cells, which can generate excess heat during operation. Heat dissipation systems can also add significant bulk and weight to a fuel cell system. Transport and aerospace use of fuel cells can be particularly sensitive to issues of excess bulk, weight, and safety. Many industries, including the transportation and aviation industries, are actively exploring carbon-neutral fuels to meet current carbon emission reduction targets. While hydrogen represents a promising technology toward these goals, there is a need for improved hydrogen fuel cell systems to achieve widespread adoption in such sectors.

### SUMMARY OF THE INVENTION

The disclosure provides a fuel cell system utilizing a liquid organic hydrogen carrier (LOHC). The system comprises a fuel cell, a dehydrogenation reactor, a coolant circuit, and a LOHC line. The fuel cell has an operating temperature about, or less than, an operating temperature of the dehydrogenation reactor. The coolant circuit is configured to circulate a coolant from a heat-exchanger of the fuel cell through a temperature lift stage to a heat-exchanger of the dehydrogenation reactor. The LOHC line is configured to provide a hydrogen-rich LOHC (LOHC_{Rich}) through a LOHC pre-heating stage to the dehydrogenation reactor. The temperature lift stage of the coolant circuit is configured to raise the temperature of the coolant. The pre-heating stage includes a heat exchanger configured to transfer heat from the coolant in the temperature lift stage to the LOHC_{Rich}.

The disclosure also provides a system having a fuel cell with a coolant circuit integrated with a LOHC system. The system is configured to provide latent heat from the fuel cell to a dehydrogenation reactor of the LOHC system. The system includes one or more heat pumps that superheat a vapor phase coolant obtained from a heat exchanger of the fuel cell, which operates about or below an operating temperature of the dehydrogenation reactor. The one or more heat pumps superheat the vapor phase coolant to above the operating temperature of the dehydrogenation reactor. The system also includes a heat exchanger that transfers sensible heat from the superheated vapor phase coolant to a LOHC_{Rich}.

Various aspects of the present disclosure can provide the advantage of improving the overall energy efficiency of hydrogen fuel cell systems. For example, various aspects can have the advantage of reducing the overall bulk, size, or weight of the fuel cell system. As a further example, various aspects can have the advantage of reducing the overall bulk, size, or extent of use of heat dissipation components of the fuel cell system. The presently described systems involve a LOHC system integrated with a coolant circuit, which solves multiple problems associated with using hydrogen as a fuel, including its storage, transport, and thermal management. These aspects can be particularly useful in applications sensitive to problems of excess bulk, size, weight, safety, or cost, such as transportation, aviation, and aerospace industries. Various aspects of the present disclosure can achieve more compact and lightweight fuel cell systems, making them more suitable for use in such sectors. These improvements can facilitate the broader adoption of hydrogen fuel cell technology across industries, contributing to a more sustainable and environmentally friendly energy landscape.

### BRIEF DESCRIPTION OF THE FIGURES

FIG. 1 provides a schematic of a fuel cell system in a first example, which involves a coolant circuit having a temperature lift stage and a liquid organic hydrogen carrier (LOHC) line having a pre-heating stage with heat exchangers utilizing a heat from coolant upstream and downstream of a dehydrogenation reactor.

FIG. 2 provides a thermodynamic cycle diagram of the coolant circuit of the system illustrated in FIG. 1.

FIG. 3 provides a schematic of a fuel cell system in a second example, which involves a coolant circuit having a temperature lift stage and a LOHC line having a pre-heating stage with a heat exchanger utilizing heat from coolant at the temperature lift stage upstream of the dehydrogenation reactor.

FIG. 4 provides a thermodynamic cycle diagram of the coolant circuit of the system illustrated in FIG. 3.

FIG. 5 provides a schematic of a fuel cell system in a third example, which involves a coolant circuit having a temperature lift stage and a LOHC line having a pre-heating stage with multiple heat exchangers utilizing heat from coolant at the temperature lift stage upstream of the dehydrogenation reactor.

FIG. 6 provides a thermodynamic cycle diagram of the coolant circuit of the system illustrated in FIG. 5.

FIG. 7 provides a schematic of a fuel cell system in a fourth example, which involves a coolant circuit having a temperature lift stage having multiple heat pumps, and a LOHC line having a pre-heating stage with heat exchangers utilizing a heat from coolant upstream and downstream of a dehydrogenation reactor.

FIG. 8 provides a thermodynamic cycle diagram of the coolant circuit of the system illustrated in FIG. 7.

FIG. 9 provides a schematic of a fuel cell system in a fifth example, which involves a coolant circuit having multiple coolant loops, a temperature lift stage, a coolant-hydrogen heat exchanger, and a LOHC line having a pre-heating stage with a heat exchanger utilizing heat from coolant at the temperature lift stage upstream of the dehydrogenation reactor.

FIG. 10 provides a thermodynamic cycle diagram of the coolant circuit of the system illustrated in FIG. 9.

FIG. 11 provides a schematic of a fuel cell system in a sixth example, which involves a coolant circuit having a single coolant loop, a temperature lift stage, a coolant-hydrogen heat exchanger, and a LOHC line having a pre-heating stage with a heat exchanger utilizing heat from coolant at the temperature lift stage upstream of the dehydrogenation reactor.

FIG. 12 provides a thermodynamic cycle diagram of the coolant circuit of the system illustrated in FIG. 11.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the disclosure, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Fuel Cell System with Liquid Organic Hydrocarbon System

The present disclosure provide a fuel cell system comprising a fuel cell, a coolant circuit, and a liquid organic hydrogen carrier (LOHC) system, which includes an LOHC dehydrogenation reactor and a supply of a hydrogen-rich LOHC (LOHC_{Rich}). The coolant circuit is configured to carry waste thermal energy produced by the fuel cell and transfer it to a dehydrogenation reactor. The fuel cell's coolant circuit is integrated with the LOHC system. En route to the dehydrogenation reactor, the heated coolant is subjected to a temperature lift stage that provides additional heat to the heated coolant, and then interfaces the further heated coolant with the LOHC system, which pre-heats the LOHC_{Rich} prior to its conveyance to the dehydrogenation reactor. In additional aspects, the disclosure provides a fuel cell system having a coolant circuit integrated with a LOHC system. The coolant circuit is configured to provide latent heat from a fuel cell to a LOHC dehydrogenation reactor, and also provide sensible heat from superheated coolant to pre-heat LOHC_{Rich} prior to its delivery to the dehydrogenation reactor. The coolant circuit uses a temperature lift stage, which includes one or more heat sources such as heat pumps to superheat vapor phase coolant generated by the fuel cell. The coolant circuit can thus be integrated with the LOHC system in multiple ways: in one way, it transfers thermal energy to the LOHC dehydrogenation reactor, and in another way it pre-heats LOHC prior to dehydrogenation. Surprisingly, despite introduction of a temperature lift stage having one or more additional heat sources, various configurations of the disclosure can have result in advantageous power delivery system which can have improved power density and better balance-of-plant with respect to one or more of size, weight, or cost. Moreover, systems of the disclosure can be suitably used with fuel cells having relatively low operating temperatures, including polymer electrolyte membrane (PEM) fuel cells and other low temperature fuel cells.

Polymer electrolyte membrane (PEM) fuel cells, also known as proton-exchange membrane fuel cells, are a type of fuel cell that uses a proton-conducting polymer electrolyte membrane and are notable among fuel cells due to their relatively low operating temperatures. PEM fuel cells include low temperature PEM fuel cells, high temperature PEM fuel cells, and intermediate temperature PEM fuel cells, yet PEM fuel cells have relatively low operating temperatures especially relative to non-PEM fuel cells. Low temperature PEM fuel cells can typically operate about or below 100° C., typically between 60° C. and 80° C. Other PEM fuel cells, which includes PEM fuel cells that can be referred to as high temperature PEM fuel cells or intermediate temperature PEM fuel cells, can operate at about or below 200° C., from about 100° C. to about 200° C., at about or below 240° C., at about or below 240° C., at about or below 250° C., at about or below 300° C., at about or below 350° C., from about 100° C. to about 250° C., from about 100° C. to about 300° C., from about 100° C. to about 350° C., from about 200° C. to about 300° C., from about 200° C. to about 350° C., from about 200° C. to about 240° C., from about 200° C. to about 250° C., from about 240° C. to about 300° C., from about 250° C. to about 350° C., from about 200° C. to about 350° C. with a typical temperature around 240° C., from about 100° C. to about 200° C. with a typical temperature around 160° C. to around 180° C., from about 100° C. to about 250° C. with a typical temperature around 160° C. to around 180° C., or, from about 80° C. to about 240° C. with a typical temperature around 160° C. to around 180° C. Examples of PEM fuel cells include “High Temperature” PEM fuel cells, which can have an operating temperature from about 100° C. to about 200° C. with a typical temperature around 160° C. to around 180° C. Other PEM fuel cells include “Intermediate Temperature” PEM fuel cells, which can have an operating temperature from about 200° C. to about 350° C. with a typical temperature around 240° C. The nomenclature for PEM fuel cells can appear inconsistent due to varying temperature references used in technical literature in the field. For example, a “High Temperature” PEM fuel cell may operate at higher temperatures than earlier generation low temperature PEM fuel cells, yet still represent a significantly lower operating temperature than non-PEM fuel cells. On the other hand, some “Intermediate Temperature” PEM fuel cells may operate at yet higher temperatures, while representing a relatively intermediate temperature nearer to the range of intermediate temperature non-PEM fuel cells. In contrast, non-PEM intermediate temperature fuel cells may operate at around 350° C. or higher, and non-PEM high temperature fuel cells may operate up to 1000° C. The relatively lower operating temperatures of PEM fuel cells are associated with certain challenges. Primarily, low operating temperatures of fuel cells can make thermal management difficult, and they can be susceptible to changes in ambient temperature that may impose greater burdens with respect to heat dissipation at certain times. Slightly higher operating temperatures such as seen in high temperature PEM fuel cells provides a more tolerant system but does not fully address these problems. PEM fuel cells generally produce approximately the same amount of thermal heat during operation as gross electric power, and yet the low operating temperature can make heat exchange difficult or inefficient.

PEM fuel cell power systems (PEMFCPSs) represents a desirable fuel cell platform due to an ability to utilize hydrogen and atmospheric oxygen as an oxidant. However, prior approaches to such technology have faced challenges with respect to scale up or use in large vehicle, aerospace, or transport contexts. Prior uses of PEMFCPS in aviation have been limited to small UAVs and drones with installed power levels ranging from 600 W to 3 kW, but far higher power levels would be used for larger craft. A range of about 500 kW to about 1 MW is one example suitable range for commercial part 25 aircraft when used for secondary power, and in urban air mobility (UAM) aircraft and part 23 aircraft when used as propulsive power and/or secondary power. Current state-of-the-art PEM fuel cells can have a power density of the order of ~4.7 kW/kg, yet overall PEMFCPS systems suffer from relative low power density, which can be less than 1.0 kW/kg even when using state of the art PEM fuel cells. However, prior approaches to PEMFCPS suffer from low power density on a system level due to the weight of the balance-of-plant components. For example, existing, prior PEMFCPS systems have required large radiators that are used due to the relatively lower operating temperature of PEMFCPS. Large, heavy auxiliary components have so far limited the adoption of PEMFCPS in vehicle and aerospace applications, yet the presence of such components on a system level stems from the mild operating conditions of PEMFCPS. The mild operating conditions of PEM fuel cells suggests use of passive radiators. PEM fuel cells can have an operating temperature that can be lower than the temperatures involved in the various possible auxiliary or adjoining systems seen in higher temperature fuel cells. For example, LOHC systems utilize a dehydrogenation reactor to extract hydrogen from the LOHC, but PEM fuel cells typically operate below the temperature of LOHC dehydrogenation reactor. Thus, PEM fuel cells would not conventionally be suitably used as a source of excess thermal energy for dehydrogenation. Indeed, conventional systems that utilize excess thermal energy from a fuel cell have relied on and require utilizing a much higher temperature fuel cells, such as a solid oxide fuel cell or SOFC.

Liquid organic hydrogen carriers (LOHC) can be useful for storing, transporting, and utilizing hydrogen as a fuel source. LOHC systems typically utilize a hydrogenated/dehydrogenated carrier pair, which can be cycloalkanes, hetero-cycloalkanes, or other small organic compounds that are conveniently hydrogenated and dehydrogenated. The LOHC pair the results in a hydrogen-lean compound and a hydrogen-rich compound, as well as resulting mixtures containing various proportions of the same. During the hydrogenation step, hydrogen is combined with the hydrogen-lean carrier (LOHC_{Lean}) in a catalytic exothermic reaction at 10-50 bar and 50-250° C. to form the hydrogen-rich carrier (LOHC_{Rich}). During the dehydrogenation step, hydrogen is released from the LOHC_{Rich} in a catalytic endothermic reaction at 1-5 bar and 150-450° C. to form the LOHC_{Lean}. Following the dehydrogenation, the LOHC_{Lean} is hydrogenated again and the cycle is repeated. LOHCs can store and release hydrogen through repeated cycles of catalytic hydrogenation and dehydrogenation reaction and stored for extended periods without energy loss.

With respect to the current challenges associated with PEM fuel cells, the present disclosure provides systems suitable for use with PEM fuel cells that provide solutions to the problems of low system-wide power density, inefficient heat management, and undesirable system weight and size. Despite the relatively low operating temperature of even high-temperature PEMFCPS (e.g., <200° C.), various aspects of the present disclosure offers a solution that improves one or more of balance-of-plant parameters, efficiency of heat dissipation, and efficient use of the thermal waste of the PEM fuel cell for LOHC dehydrogenation. In various aspects, such advantages can be the surprising result of introducing an additional beating feature: a temperature lift stage, which can involve one or more heating source such as a heat pump to further heat the already-heated coolant received from the PEM fuel cell. The further heated coolant is then utilized to pre-heat LOHC_{Rich} and then further utilized to heat a LOHC dehydrogenation reaction which receives the pre-heated LOHC_{Rich}. Systems of the present disclosure can also be suitable used with other fuel cells that operate about or below an operating temperature of the incorporated LOHC dehydrogenation reactor. As such, the present disclosure can provide a solution to problems associated with low temperature fuel cells and their integration with LOHC systems, as well as reducing the extent to which passive heat dissipation is relied upon for such low temperature fuel cells. The systems described here can utilize R718, water, or other coolant to undergo a phase change from supercooled liquid or wet vapor to a superheated state as it absorbs the heat generated by the fuel cell. This heat, stored within the coolant as latent heat of evaporation, is later used to provide the endothermic heat of dehydrogenation. During the dehydrogenation step, the coolant can undergo a phase change from superheated vapor to supercooled liquid state, thereby releasing the stored latent heat. Use of a temperature lift stage can facilitate superheating of the heated coolant being conveyed to the dehydrogenation reactor, and subsequently the sensible heat of the super heated coolant can be consumed for preheating the LOHC to the target reaction temperature of the dehydrogenation reactor. At the same time, the coolant circuit can be configured to arrive at the dehydrogenation reactor with a temperature at or near the reactor's operational temperature. Since, a large part of the heat generated by the fuel cell is now consumed for preheating the LOHC to the reaction temperature and in the endothermic dehydrogenation reaction, the size, bulk, or weight of the heat dissipation radiators is significantly reduced.

In various aspects, the fuel cell system of the present disclosure can include a fuel cell, a coolant circuit, a LOHC line, and a LOHC dehydrogenation reactor. The fuel cell can have an operating temperature about, or less than, an operating temperature of the dehydrogenation reactor. The coolant circuit serves to dissipate heat from the fuel cell, and it is configured to circulate a coolant from a heat-exchanger of the fuel cell through a temperature lift stage to a heat-exchanger of the dehydrogenation reactor. The LOHC line is configured to provide a LOHC_{Rich} to a dehydrogenation reactor to generate hydrogen for use in the fuel cell. The LOHC line can include a pre-heating stage where LOHC_{Rich} is heated prior to delivery to the dehydrogenation reactor. As shown herein, heat exchangers in both the pre-heating stage of the LOHC line and the LOHC dehydrogenation reactor can be advantageously integrated with the coolant circuit. The temperature lift stage of the coolant circuit includes one or more heat source such as a heat pump configured to raise the temperature of the coolant. This temperature lift can involve superheating vapor phase coolant, and the resulting superheated coolant can be directed to a heat exchanger of the pre-heating stage of the LOHC line. The coolant can be subsequently directed to the LOHC dehydrogenation reactor to facilitate heating of the reactor.

In various aspects, the coolant circuit can be configured to provide latent heat from the fuel cell to the dehydrogenation reactor. In various further aspects, the coolant circuit can be configured for phase change cooling at the fuel cell so that the fuel cell receives coolant that is at fully or partially liquid phase and provides a coolant that is fully vapor (or gas) phase. The coolant circuit can be configured to maintain a vapor phase of the coolant through to the dehydrogenation reactor. The coolant circuit can be configured for the coolant to undergo a phase change from liquid phase to vapor phase at the heat exchanger of the fuel cell, and to undergo a phase change from vapor phase to liquid phase at the heat exchanger of the dehydrogenation reactor. The coolant circuit can be configured to maintain the coolant in two phase while transferring heat from the coolant to the LOHC. In various aspects, the two phase coolant that is transferring heat away from the fuel cell is further heated, or superheated, at the temperature lift stage. The coolant circuit can also be configured to provide sensible heat obtained at the temperature lift stage to heat one or more component of the LOHC line. In various aspects, the temperature lift stage can be configured to provide sensible heat transfer from the coolant to LOHC_{Rich} prior to delivery of the LOHC_{Rich} to the dehydrogenation reactor. In various further aspects, the temperature lift stage can be configured to provide sensible heat transfer from the coolant to the LOHC_{Lean}, such as in the LOHC_{Lean} return reservoir. In various yet further aspects, the temperature lift stage provides sensible heat transfer at one or more components of an LOHC system, such as any combination of the various specified examples described herein.

In various aspects, the coolant comprises water. In various aspects, the coolant is R718 or water. In various aspects, the LOHC comprises or is selected from dodecahydro-N-ethylcarbazole/N-ethylcarbazole, methylcyclohexane/toluene, cyclohexane/benzene, decalin/naphthalene, or perhydro-dibenzyltoluene/dibenzyltoluene. In various aspects, the fuel cell is a polymer electrolyte membrane (PEXM) fuel cell, such as a low temperature PE M fuel cell or a high temperature PEM fuel cell. In various aspects, the fuel cell is not a solid-oxide fuel cell.

In various aspects, the fuel cell has an operating temperature of about or less than 350° C., 340° C., 330° C., 320° C., 310° C., 300° C., 290° C., 280° C., 270° C., 260° C., 250° C., 240° C., 230° C., 220° C., 210° C., 200° C., 190° C., 180° C., 170° C., 160° C., 150° C., 140° C., 130° C., 120° C., 110° C., 100° C., 90° C., 80° C., 70° C., 60° C., or 50° C. In various aspects, the fuel cell has an operating temperature of about 50° C. to about 200° C., about 50° C. to about 250° C., about 80° C. to about 180° C., about 60° C. to about 240° C., about 100° C. to about 200° C., about 100° C. to about 240° C., about 80° C. to about 210° C., about 120° C. to about 220° C., about 150° C. to about 250° C., or about 150° C. to about 200° C. In various aspects, the fuel cell has an operating temperature having a range between any combination of two values selected from the following list: 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., 300° C., 310° C., 320° C., 330° C., and 340° C. In various aspects, the fuel cell has an operating temperature about or less than an integrated LOHC dehydrogenation reactor. In various aspects, the fuel cell has an operating temperature about 0° C., 10° C., 20° C., 30° C., 40° C., 50° C., 60° C., 70° C., 80° C., 90° C., or 100° C., 110° C., 120° C., 130° C., 140° C., 160° C., 170° C., 180° C., 190° C., 200° C., 210° C., 220° C., 230° C., 240° C., or 250° C. less than the operating temperature of the LOHC dehydrogenation reactor.

In various aspects, dehydrogenation reactor can have an operating temperature of about or less than about 450° C., 440° C., 430° C., 420° C., 410° C., 400° C., 390° C., 380° C., 370° C., 360° C., 350° C., 340° C., 330° C., 320° C., 310° C., 300° C., 290° C., 280° C., 270° C., 260° C., 250° C., 240° C., 230° C., 220° C., 210° C., 200° C., 190° C., 180° C., 170° C., 160° C., 150° C., 140° C., 130° C., or 120° C. In various aspects, dehydrogenation reactor can have an operating pressure of about 1, 2, 3, 4, or 5 bar, or a range of any two values therein. In various aspects, dehydrogenation reactor can have an operating pressure of 1-5 bar and an operating temperature of about 450° C., 440° C., 430° C., 420° C., 410° C., 400° C., 390° C., 380° C., 370° C., 360° C., 350° C., 340° C., 330° C., 320° C., 310° C., 300° C., 290° C., 280° C., 270° C., 260° C., 250° C., 240° C., 230° C., 220° C., 210° C., 200° C., 190° C., 180° C., 170° C., 160° C., or 150° C., or a range between any two temperatures therein.

In various aspects, the temperature lift stage comprises one, two, or more heat pumps. In various aspects, the temperature lift stage comprises an intercooler intervening between two heat pumps. The temperature lift stage can be configured to raise a temperature of the coolant to above the operating temperature of the dehydrogenation reactor. In various aspects, the temperature lift stage superheats the coolant. In various aspects, the temperature lift stage compresses the coolant. The temperature lift stage can be configured to raise a temperature of the coolant by about 25° C. to about 35° C. above the operating temperature of the dehydrogenation reactor. The temperature lift stage can be configured to raise a temperature of the coolant by about 0° C., 5° C., 10° C., 15° C., 20° C., 25° C., 30° C., 25° C., 40° C., 45° C., 50° C., 60° C., 70° C., 80° C., 90° C., or 100° C., above the operating temperature of the dehydrogenation reactor. The temperature lift stage can be configured to maintain the coolant in a two phase while transferring heat from the coolant to the LOHC. The temperature lift stage can be configured to maintain the coolant in a vapor phase to the heat exchanger of the dehydrogenation reactor.

In various aspects, the temperature lift stage can be configured to heat the coolant to a temperature above the operating temperature of the dehydrogenation reactor. In various aspects, the temperature lift stage can be configured to heat the coolant by about or at least 5° C., 10° C., 15° C., 20° C., 25° C., 30° C., 25° C., 40° C., 45° C., 50° C., 60° C., 70° C., 80° C., 90° C., or 100° C., above the operating temperature of the dehydrogenation reactor.

In various aspects, the temperature lift stage can be configured to heat the coolant to a temperature above the temperature at which the coolant is supplied to the dehydrogenation reactor. In various aspects, the temperature lift stage can be configured to heat the coolant by about or at least 5° C., 10° C., 15° C., 20° C., 25° C., 30° C., 25° C., 40° C., 45° C., 50° C., 60° C., 70° C., 80° C., 90° C., or 100° C., above the temperature at which the coolant is supplied to the dehydrogenation reactor.

In various aspects, the temperature lift stage accepts a coolant at a temperature below the temperature of the dehydrogenation reactor. In various aspects, the temperature lift stage accepts a coolant at a temperature below the temperature of the dehydrogenation reactor by about or at least 5° C., 10° C., 15° C., 20° C., 25° C., 30° C., 25° C., 40° C., 45° C., 50° C., 60° C., 70° C., 80° C., 90° C., or 100° C.,

In various aspects, the temperature lift stage includes or is followed by one, two, or more heat exchanges with the LOHC system prior to the coolant being delivered to the dehydrogenation reactor.

In various aspects, the temperature lift stage includes or is followed by one, two, or more heat exchanges that transfer heat from the coolant to the LOHC system prior to the coolant being delivered to the dehydrogenation reactor.

In various aspects, the temperature lift stage includes or is followed by one, two, or more heat exchanges that transfer heat from the coolant to the LOHC system, hydrogen supply line, or both, prior to the coolant being delivered to the dehydrogenation reactor.

In various aspects, the temperature lift stage comprises an intercooler between two or more heat pumps. In various aspects, the temperature lift stage comprises an intercooler between two or more heat pumps, wherein the intercooler comprises a heat exchanger that transfer heat from the coolant to the LOHC system, hydrogen supply line, or both, prior to the coolant being delivered to the dehydrogenation reactor. In various aspects, the intercooler is configured to transfer heat away from the coolant but maintain the coolant as a vapor phase. In various aspects, the intercooler is configured to isobarically transfer heat away from the coolant. In various aspects, the intercooler is configured to shift the coolant to approximately, or in the direction of, the phase transition boundary. In various aspects, the temperature lift stage comprises an intercooler between two or more heat pumps, wherein the intercooler comprises a heat exchanger that transfer heat from the coolant to the LOHC system, hydrogen supply line, or both, prior to the coolant being delivered to the dehydrogenation reactor.

In various aspects, the dehydrogenation reactor can have an operating temperature of about or less than about 450° C., 440° C., 430° C., 420° C., 410° C., 400° C., 390° C., 380° C., 370° C., 360° C., 350° C., 340° C., 330° C., 320° C., 310° C., 300° C., 290° C., 280° C., 270° C., 260° C., 250° C., 240° C., 230° C., 220° C., 210° C., 200° C., 190° C., 180° C., 170° C., 160° C., 150° C., 140° C., 130° C., or 120° C. In various aspects, the dehydrogenation reactor can have an operating pressure of about 1, 2, 3, 4, or 5 bar, or a range of any two values therein. In various aspects, dehydrogenation reactor can have an operating pressure of 1-5 bar and an operating temperature of about 450° C., 440° C., 430° C., 420° C., 410° C., 400° C., 390° C., 380° C., 370° C., 360° C., 350° C., 340° C., 330° C., 320° C., 310° C., 300° C., 290° C., 280° C., 270° C., 260° C., 250° C., 240° C., 230° C., 220° C., 210° C., 200° C., 190° C., 180° C., 170° C., 160° C., or 150° C., or a range between any two temperatures therein.

In various aspects, the fuel cell system can be configured as a source of secondary power or propulsive power for a vehicle. The vehicle can be a transport vehicle, an observation vehicle, a piloted vehicle, or an unmanned vehicle. The vehicle can be a drone or other than a drone. The vehicle can be an aircraft or a spacecraft.

Reference will now be made in detail to certain aspects of the disclosed subject matter, several examples of which are illustrated in part in the accompanying drawings. While the disclosed subject matter will be described in conjunction with the enumerated claims, it will be understood that the exemplified subject matter is not intended to limit the claims to the disclosed subject matter. The system configurations presented here are exemplary in nature.

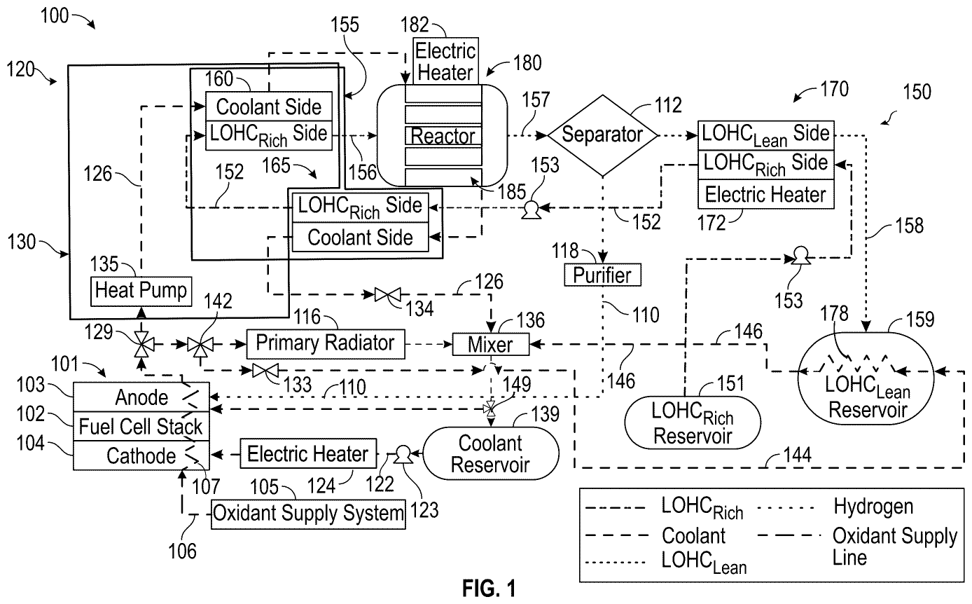

FIG. 1 provides a schematic of a fuel cell system 100, which involves fuel cell 101 with a coolant circuit 120 and a LOHC system 150.

The fuel cell 101 includes a fuel cell stack 102, anode 103, and cathode 104. The fuel cell utilizes hydrogen obtained from hydrogen supply line 110 and an oxidant obtained from an oxidant supply system 105. An oxidant supply system 105 provides oxidant to the fuel cell 101 via a oxidant supply line 106. The oxidant can be atmospheric oxygen or oxygen enriched air. Operation of the fuel cell 101 provides electricity and thermal energy. The fuel cell 101 is cooled by the coolant circuit 120, which interfaces with the fuel cell 101 through a coolant-fuel cell heat exchanger 107. The coolant-fuel cell heat exchanger 107 is configured to transfer away excess thermal energy generated by the fuel cell 101 via vaporization of the supplied coolant.

The present fuel cell system can be advantageously used with relatively low temperature fuel cells. For example, the fuel cell 101 can a polymer electrolyte membrane (PEM) fuel cell, including a low temperature PEM fuel cell, an intermediate temperature PEM fuel cell, or a high temperature PEM fuel cell. The fuel cell 101 can be other than a solid-oxide fuel cell. The fuel cell 101 can be other than a molten carbonate fuel cell. The fuel cell 101 can be a phosphoric acid fuel cell. The fuel cell 101 can be other than a phosphoric acid fuel cell. The fuel cell 101 can be an alkaline fuel cell. The fuel cell 101 can be other than an alkaline fuel cell. The fuel cell 101 can be a fuel cell having an operating temperature below typically between 60° C. and 100° C. High temperature PEM fuel cells can typically operate about or below 400° C., 350° C., 300° C., 290° C., 280° C., 270° C., 260° C., 250° C., 240° C., 230° C., 220° C., 210° C., 200° C., 190° C., 180° C., 170° C., 160° C., 150° C., 140° C., 130° C., 120° C., 110° C., or 100° C. The fuel cell 101 can be a fuel cell having an operating temperature about 0° C., 1° C., 2° C., 3° C., 4° C., 5° C., 6° C., 7° C., 8° C., 9° C., 10° C., 15° C., 20° C., or 25° C., below the operation temperature of a LOHC dehydrogenation reactor integrated to share a coolant circuit 120. The fuel cell 101 can be a fuel cell having an operating temperature within about 0° C., 1° C., 2° C., 3° C., 4° C., 5° C., 6° C., 7° C., 8° C., 9° C., 10° C., 15° C., of the operation temperature of a LOHC dehydrogenation reactor integrated to share a coolant circuit 120.

The coolant circuit 120 utilizes one or more coolant, which can be optionally configured in one or more coolant loops, to capture latent heat from the fuel cell 101 and deliver it to the dehydrogenation reactor 180 of the LOHC system 150. Suitable coolants can comprise water, alcohols, glycols, or a combinations thereof. In various aspects, the coolant preferably comprises water. In various aspects, the coolant is R718. In various aspects, the coolant is water.

Coolants can be selected based on the operating temperature of the fuel cell 101, dehydrogenation reactor, or other components. Typically, the coolant and system is configured so that operation of the fuel cell 101 will induce phase change vaporization of the coolant at a coolant-fuel cell heat exchanger 107 thus capturing waste thermal energy as latent heat. The coolant and system can be further configured to assure that the coolant's vapor phase is maintained stages of the coolant circuit, particularly the temperature lift phase, and one or more pre-reactor heat exchangers. Such configuration can permit the coolant to vaporize at the fuel cell carrying latent heat away, maintain vapor phase through one or more heat pump in a temperature lift stage which superheats the vapor phase coolant, and maintain vapor phase through one or more coolant-LOHC heat exchanger so as to transfer sensible heat from the superheated vapor phase coolant to the LOHC, and maintain vapor phase for arrival at the dehydrogenation reactor. The coolant can also be selected so as to partially or fully condense during heat dissipation at the reactor.

The coolant circuit 120 provides coolant to the fuel cell 101 via a coolant supply line 122. In various aspects, the supplied coolant is liquid phase coolant. The coolant can be optionally heated via a coolant supply electric heater 124 to warm the liquid phase prior to delivery to the fuel cell 101. At the fuel cell, the coolant passes through a coolant-fuel cell heat exchanger 107 to absorb thermal waste, preferably vaporizing to provide a vapor phase coolant that is transferred away from the fuel cell 101 toward the dehydrogenation reactor 180 via a coolant return line 126. The coolant circuit 120 includes a temperature lift stage 130. As vapor phase coolant travels from the fuel cell 101 to the dehydrogenation reactor 180 it is passed through a temperature lift stage 130, which includes one or more heat source such as a heat pump 135 to further heat the vapor phase coolant. The temperature lift stage 130 can superheat the vapor phase coolant. The further heated vapor phase coolant is conveyed to a pre-reactor coolant-LOHC_{Rich} heat exchanger 160. This heat exchanger transfers heat away from the heated coolant to the LOHC_{Rich} ahead of the dehydrogenation reactor 180. In various aspects, the pre-reactor coolant-LOHC_{Rich} heat exchanger 160 is configured to transfer sensible heat away from the heated vapor phase coolant. The coolant is then transferred to the dehydrogenation reactor 180. The LOHC is transferred via the LOHC_{Rich} reactor inlet 156 to the dehydrogenation reactor 180. The dehydrogenation reactor 180 includes a coolant-reactor heat exchanger 185, which serves to transfer heat from the coolant to the LOHC reaction mixture to facilitate dehydrogenation, which may optionally utilize one or more additional heat sources such as an reactor electric heater 182. In various aspects, the coolant is a vapor phase coolant when it is provided to the dehydrogenation reactor 180, the coolant undergoes phase change at the coolant-reactor heat exchanger 185 so as to transfer latent heat to the dehydrogenation reactor 180, or both. The coolant is then conveyed away from the dehydrogenation reactor 180 for further use, expansion, and/or recirculating through the coolant circuit 120.

As illustrated in FIG. 1, the coolant is conveyed from the dehydrogenation reactor 180 to a post-reactor coolant-LOHC_{Rich} heat exchanger 165. The post-reactor coolant-LOHC_{Rich} heat exchanger 165 can be configured as a low-temperature heat exchanging that serves to partially heat the LOHC_{Rich} prior to the pre-reactor coolant-LOHC_{Rich} heat exchanger 160 and dehydrogenation reactor 180. After the post-reactor coolant-LOHC_{Rich} heat exchanger 165, the coolant is sent to an expander 134 and then subsequently collected for reuse in the coolant circuit 120. The coolant is provided to a mixer 136, which collects coolant dissipated at other sinks such as radiators or storage reservoirs. The coolant circuit 120 dissipates heat from the fuel cell 101 at the dehydrogenation reactor 180, but it also will typically dissipate heat at one or more primary radiator 116. In various aspects, the coolant circuit is configured with configurable diversions via one or more flow diverter 129 or bypass valve 142. For example, a flow diverter 129 can be used to control how much heated coolant is sent to the dehydrogenation reactor 180 and how much is sent to one or more primary radiator 116. One or more functional valve 133 can be included to provide a control function. Further use of a bypass valve 142 after the flow diverter 129 can optionally be used to divert a portion of heated coolant to one or more storage reservoirs or component of the LOHC system. As illustrated in FIG. 1, the bypass valve 142 diverts heated coolant to a coolant bypass supply line 144 that supplies a coolant-LOHC_{Lean} return heat exchanger 178 at the LOHC_{Lean} return 159 where LOHC_{Lean} is stored for removal for rehydrogenation. The coolant is returned from the coolant-LOHC_{Lean} return heat exchanger 178 via a coolant bypass return line 146 to the mixer 136 and combined with coolant utilized in the other heat exchangers. The combined coolant, which can be substantially liquid, is collected in a coolant reservoir 139 which serves as a coolant supply. The supply coolant is provided to the fuel cell 101 via the coolant supply line 122, which can include one or more coolant supply pump 123 or coolant supply electric heater 124. A direct supply valve 149 can be located between the mixer 136 and the coolant reservoir 139. When activated, the direct supply valve 149 can provide returned coolant directly to the fuel cell 101, which can be useful after the system is started when the supply line electric heater 124 is not being utilized.

The LOHC system 150 includes a dehydrogenation reactor 180 that receives LOHC_{Rich} via a LOHC_{Rich} supply line 152, which utilizes one or more LOHC supply pumps 153 to convey LOHC from a LOHC_{Rich} supply 151 to an LOHC_{Lean} return 159. The dehydrogenation reactor 180 extracts hydrogen from the LOHC_{Rich}, resulting in a mixture of hydrogen and LOHC_{Lean}. The mixture of hydrogen and LOHC_{Lean} is then sent through a LOHC_{Lean} outlet 157 to a hydrogen separator 112 to isolate hydrogen from LOHC_{Lean}. Hydrogen is delivered to the fuel cell 101 via a hydrogen supply line 110, which can include a purifier 118 en route. The LOHC_{Lean}, which is warm from the reactor, can be utilized in a LOHC_{Rich}-LOHC_{Lean} heat exchanger 170, to provide further pre-heating of the LOHC_{Rich} prior to its arrival at the subsequent coolant-LOHC heat exchangers. After the LOHC_{Rich}-LOHC_{Lean} heat exchanger 170, the LOHC_{Lean} is removed via a LOHC_{Lean} return line 158 which delivers the LOHC_{Lean} to a LOHC_{Lean} return 159 for storage in a reservoir or sent for rehydrogenation for regeneration of the LOHC_{Rich}. The LOHC system 150 can include a LOHC pre-heating stage 155 where the LOHC_{Rich} is heated prior to entering the dehydrogenation reactor 180. This pre-heating can be achieved by using one or more heat exchangers, which can interface with the coolant circuit either before or after circulation of the coolant through the dehydrogenation reactor 180. The pre-heating stage 155 can be configured with a single high temperature heat exchanger (which can be the pre-reactor coolant-LOHC_{Rich} heat exchanger 160), or can be configured with one or more initial lower temperature heat exchanger (which can be the post-reactor coolant-LOHC_{Rich} heat exchanger 165) followed by the high temperature heat exchanger (which can be the pre-reactor coolant-LOHC_{Rich} heat exchanger 160). A high temperature heat exchanger can interface, for example, with coolant at or following the temperature lift stage 130 of the coolant circuit 120. In various aspects, a low temperature heat exchanger such as the post-reactor coolant-LOHC_{Rich} heat exchanger 165 can interface with coolant exiting the dehydrogenation reactor 180. The example system illustrated in FIG. 1 utilizes a post-reactor coolant-LOHC_{Rich} heat exchanger 165, which serves as a lower temperature heat exchanger, and a pre-reactor coolant-LOHC_{Rich} heat exchanger 160, which serves as a higher temperature heat exchanger that heats a temperature at or near the dehydrogenation reactor operation temperature. The LOHC system 150 is integrated with the coolant circuit 120 by interfacing at or following the temperature lift stage 130. Such configuration can permit efficient dissipation of latent heat from the fuel cell 101 to the dehydrogenation reactor 180, while providing efficient transfer of sensible heat from the temperature lift stage 130 to the LOHC pre-heating stage 155.

An example system (Example 1) was modeled based on a system architecture according to FIG. 1, using dodecahydro-N-ethylcarbazole/N-ethylcarbazole as a LOHC rich-lean pair. The modeled operation of the fuel cell power system, involves several assumptions and simplifications. The fuel cell power system incorporates one or more fuel cell stacks with a gross power output of 625.0 kW. It is assumed that the fuel cell stack has an overall efficiency of approximately 50% and operates at an average temperature of 180° C. Furthermore, no pressure drop within the coolant system has been considered. The efficiency of the dehydrogenation reaction is assumed to be 80%.

In Example 1, a fuel cell 101 operating at an average temperature of 180° C. incorporates a coolant circuit 120 that employes refrigerant R718 (water) as a coolant. The cooling of the fuel cell 101 follows the “cooling through boiling” principle. The coolant enters the fuel cell 101 as wet vapor at a temperature and pressure of 179.878° C. and 10 bar, respectively, with 0.06856 quality. As the beat generated by the fuel cell 101 is transferred to the coolant, it gradually undergoes phase change before leaving the fuel cell 101 as a superheated vapor at 185° C. with 5.122° C. of superheat. The net heat transferred to the coolant in the fuel cell 101 is 624.25 kW. After leaving the fuel cell 101, a portion of the coolant is transferred to a heat pump 135 where its temperature is increased to 275.1° C., corresponding to a temperature “lift” of 90.1° C. The pressure ratio across the heat pump is assumed to be 2.0. The power consumed by the heat pump 135 is 36.9 kW, assuming mechanical and electrical efficiencies of 85% and 95%, respectively. The remaining portion of coolant is redirected to the primary radiator 116 (air-cooled) where it exchanges heat with the environment, with the ambient air acting as the final heat sink. The net heat dissipation from the primary radiator 116 into the ambient air is 244.69 kW. Since hydrogen lean N-ethylcarbazole is solid at room temperature (melting point 68-70° C.), a fraction of the coolant that is routed to the primary radiator 116 is diverted to the hydrogen lean LOHC return 159 to provide heat to keep the N-ethylcarbazole and the reaction intermediaries in the liquid phase for ease of ground handling and transportation. From the heat pump 135, the coolant is channeled to a pre-reactor coolant-LOHC_{Rich} heat exchanger 160 to preheat the hydrogen-rich dodecahydro-N-ethylcarbazole, i.e., the LOHC_{Rich}, from 119.815° C. to its final dehydrogenation temperature of 180° C. The net heat transfer within the pre-reactor coolant-LOHC_{Rich} heat exchanger 160 is 33.5 kW. In the process, the temperature of the coolant reduces from 275.1° C. to 212.377° C. and its phase changes from superheated vapor to saturated vapor. After exiting the pre-reactor coolant-LOHC_{Rich} heat exchanger 160, the coolant is transferred to the dehydrogenation reactor 180. Within the dehydrogenation reactor 180, while supplying the endothermic heat of dehydrogenation of 379.5 kW, the coolant progressively transitions from saturated vapor to saturated liquid phase. To facilitate heat transfer between the LOHC_{Rich} and coolant, a temperature difference of 32.377° C. is maintained throughout the dehydrogenation reaction. The coolant leaving the dehydrogenation reactor 180 is then routed to the post-reactor coolant-LOHC_{Rich} heat exchanger 165 to partially preheat the LOHC_{Rich} from 116.818° C. to 119.815° C. During this stage, the temperature of the coolant reduces from 212.377° C. to 210.65° C. and its phase changes from saturated liquid to supercooled liquid with 1.73° C. of supercooling. The net heat transfer within the post-reactor coolant-LOHC_{Rich} heat exchanger 165 is 1.58 kW. The supercooled coolant is then expanded and transferred to a mixer 136 where it merges with the coolant streams returning from the primary radiator 116 and from the hydrogen lean LOHC return 159 before returning to the fuel cell 101. The quality of the coolant leaving the mixer 136 is 0.06856. The LOHC system 150 of Example 1 utilizes dehydrogenation of hydrogen-rich dodecahydro-N-ethylcarbazole (the LOHC_{Rich}) as a two-step process: preheating followed by dehydrogenation. The LOHC_{Rich} at 25° C. is first partially preheated to a temperature of 116.818° C. in the LOHC_{Rich}-LOHC_{Lean} heat exchanger 170 using the hot reaction products exiting the dehydrogenation reactor 180, and optionally with electric heater 172. The net heat transfer within the LOHC_{Rich}-LOHC_{Lean} heat exchanger 170 is 44.37 kW. From the LOHC_{Rich}-LOHC_{Lean} heat exchanger 170, dodecahydro-N-ethylcarbazole is routed to the post-reactor coolant-LOHC_{Rich} heat exchanger 165 where it is further heated to a temperature of 119.815° C. before it is transferred to the pre-reactor coolant-LOHC_{Rich} heat exchanger 160. The net heat transfer within the post-reactor coolant-LOHC_{Rich} heat exchanger 165 is 1.58 kW. In the pre-reactor coolant-LOHC_{Rich} heat exchanger 160, dodecahydro-N-ethylcarbazole is preheated to its final dehydrogenation temperature of 180° C. and then sent to the dehydrogenation reactor 180. The net heat transfer within the pre-reactor coolant-LOHC_{Rich} heat exchanger 165 is 33.5 kW. In the reactor of Example 1, dodecahydro-N-ethylcarbazole is dehydrogenated in the presence of a catalyst. The dehydrogenation products, constituting of a mixture of liquid N-ethylcarbazole, various liquid dehydrogenation reaction intermediaries such as tetrahydro-N-ethylcarbazole and octahydro-N-ethylcarbazole, and gaseous hydrogen are first separated into liquid and gaseous constituents in the separator 112. The liquid constituents are recirculated through the LOHC_{Rich}-LOHC_{Lean} heat exchanger 170 before it is discharged into the LOHC_{Lean} return 159. The gaseous hydrogen is purified in the purifier 118 and routed to the fuel cell 101.

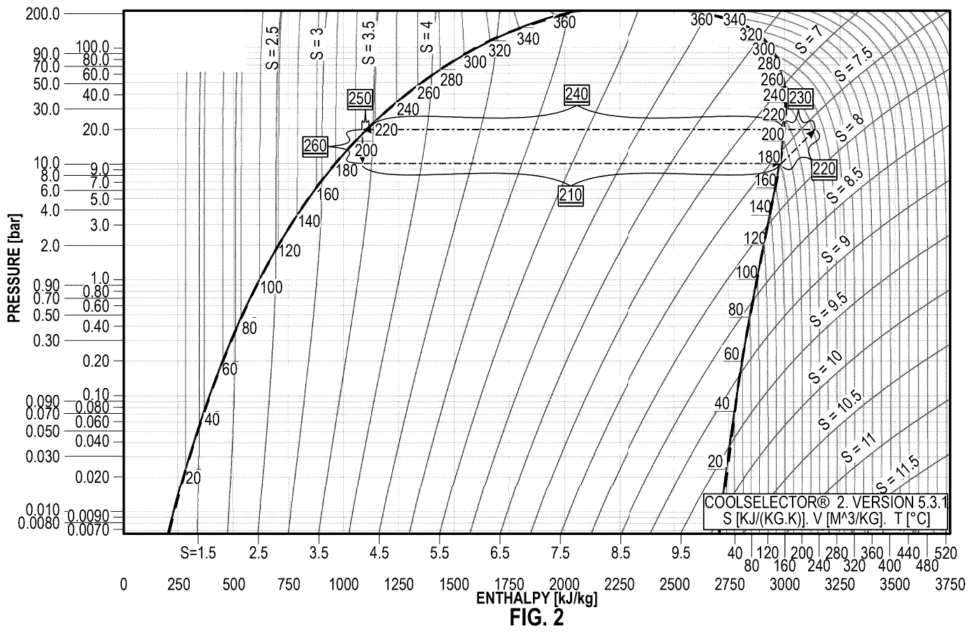

FIG. 2 provides a thermodynamic cycle diagram of the portion of the coolant circuit 120 of the system illustrated in FIG. 1 that transfers heat from the fuel cell 101 to the dehydrogenation reactor 180 and circulates the coolant back to the fuel cell 101. The fuel cell cooling branch 210 represents the process of coolant accepting heat from the fuel cell 101 at a coolant-fuel cell heat exchanger 107, which results in phase change of the coolant from liquid coolant to vapor coolant. The coolant leaves the fuel cell 101 and passed through a temperature lift stage 130 which includes a heat pump 135. The heat pump branch 220 represents a compression superheating process that serves to further heat the vaporized coolant. The superheated coolant is then passed through pre-reactor coolant-LOHC_{Rich} heat exchanger 160 at high temperature to transfer heat from the coolant circuit 120 to the LOHC system 150. The high temperature heat exchanger branch 230 represents transfer of sensible heat from the coolant to the LOHC_{Rich} in the LOHC pre-heating stage 155. Here, the vapor phase can be maintained. Then, the vapor phase coolant is provided to a coolant-reactor heat exchanger 185 in the dehydrogenation reactor 180. The dehydrogenation branch 240 represents the coolant-reactor heat exchange, where the coolant dissipates its heat to facilitate the endothermic dehydrogenation process and in the processes condenses and delivers the latent heat captured from the fuel cell. After the dehydrogenation reactor 180, the coolant can still be used for low temperature heat exchanges, such as part of the LOHC pre-heating stage 155 where a lower temperature heat exchanger, namely the post-reactor coolant-LOHC_{Rich} heat exchanger 165 is used prior to a higher temperature coolant-LOHC heat exchanger such as the pre-reactor coolant-LOHC_{Rich} heat exchanger 160. The low temperature heat exchanger branch 250 represents the heat exchange at the lower temperature post-reactor coolant-LOHC_{Rich} heat exchanger 165. Lastly, the coolant is delivered to an expander 134 and then subsequently collected for recirculation to the fuel cell 101. The expansion branch 260 represents the expansion that completes the cycle.

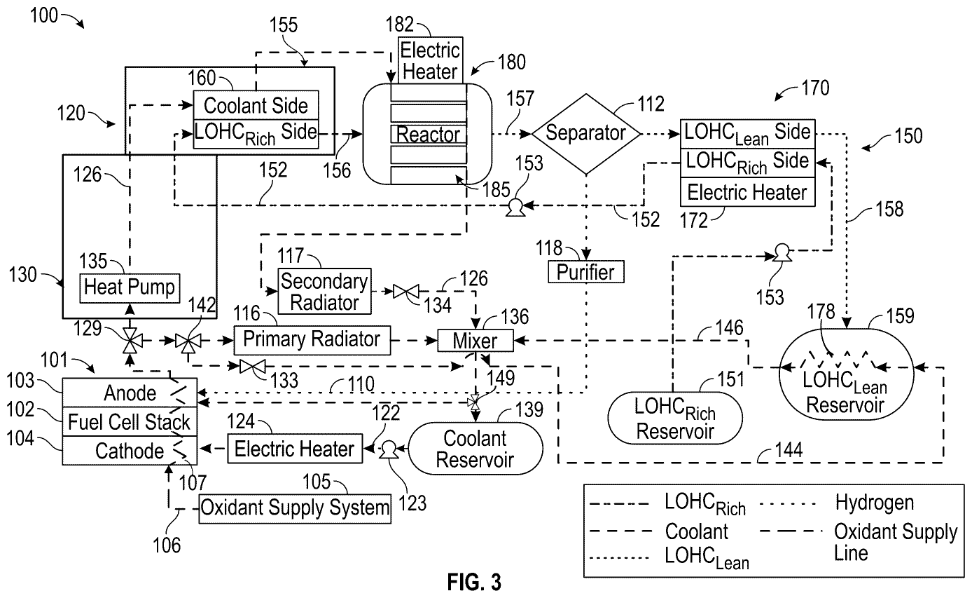

FIG. 3 provides a schematic of a fuel cell system 100 in a second example, which involves a coolant circuit 120 having a temperature lift stage 130 and a LOHC system 150 having a LOC pre-heating stage 155 with a heat exchanger utilizing heat from coolant at the temperature lift stage upstream of the dehydrogenation reactor. The fuel cell system 100 includes a fuel cell stack 102, an anode 103, and a cathode 104. The fuel cell 101 utilizes hydrogen obtained from a hydrogen supply line 110 and an oxidant obtained from an oxidant supply system 105. The oxidant supply system 105 provides oxidant to the fuel cell 101 via an oxidant supply line 106. The operation of the fuel cell 101 generates electricity and thermal energy. The fuel cell 101 is cooled by the coolant circuit 120, which interfaces with the fuel cell 101 through a coolant-fuel cell heat exchanger 107. The coolant-fuel cell heat exchanger 107 transfers excess thermal energy generated by the fuel cell 101 via vaporization of the supplied coolant. The coolant circuit 120 utilizes one or more coolants, which can be optionally configured in one or more coolant loops, to capture latent heat from the fuel cell 101 and deliver the latent heat to the dehydrogenation reactor 180 of the LOHC system 150. In various aspects, the coolant is water. The coolant circuit 120 provides coolant to the fuel cell 101 via a coolant supply line 122. The supplied coolant is liquid phase coolant. The coolant can be optionally heated via a coolant supply electric heater 124 to warm the liquid phase prior to delivery to the fuel cell 101. At the fuel cell, the coolant passes through a coolant-fuel cell heat exchanger 107 to absorb thermal waste, preferably vaporizing to provide a vapor phase coolant that is transferred away from the fuel cell 101 toward the dehydrogenation reactor 180 via a coolant return line 126. The coolant circuit 120 includes a temperature lift stage 130. As vapor phase coolant travels from the fuel cell 101 to the dehydrogenation reactor 180, the vapor phase coolant is passed through a temperature lift stage 130, which includes a heat pump 135 to further heat the vapor phase coolant. The temperature lift stage 130 can superheat the vapor phase coolant. The further heated vapor phase coolant is conveyed to a pre-reactor coolant-LOHC_{Rich} heat exchanger 160. This heat exchanger transfers heat away from the heated coolant to the LOHC_{Rich} ahead of the dehydrogenation reactor 180. The coolant is then transferred to the dehydrogenation reactor 180. The LOHC is transferred via the LOHC_{Rich} reactor inlet 156 to the dehydrogenation reactor 180. The dehydrogenation reactor 180 includes a coolant-reactor heat exchanger 185, which transfers heat from the coolant to the LOHC reaction mixture to facilitate dehydrogenation, which may optionally utilize a heater 182. The coolant undergoes phase change at the coolant-reactor heat exchanger 185 to transfer latent heat to the dehydrogenation reactor 180. The coolant is then conveyed away from the dehydrogenation reactor 180 for further heat dissipation at a secondary radiator 117, then expansion, or then recirculating through the coolant circuit 120. After the secondary radiator 117, the coolant is sent to an expander 134 and then subsequently collected for reuse in the coolant circuit 120. The cooled coolant is provided to a mixer 136, which collects coolant dissipated at other sinks such as radiators or storage reservoirs. The coolant circuit 120 dissipates heat from the fuel cell 101 at the dehydrogenation reactor 180 and typically dissipates heat at a primary radiator 116. The coolant circuit is configured with configurable diversions via a flow diverter 129 or bypass valve 142. For example, a flow diverter 129 controls how much heated coolant is sent to the dehydrogenation reactor 180 and how much is sent to the primary radiator 116. A bypass valve 142 after the flow diverter 129 can divert a portion of heated coolant to one or more storage reservoirs or components of the LOHC system. One or more functional valve 133 can be included to provide a control function. The bypass valve 142 diverts heated coolant to a coolant bypass supply line 144 that supplies a coolant-LOHC_{Lean} return heat exchanger 178 at the LOHC_{Lean} return 159 where LOHC_{Lean} is stored for removal for rehydrogenation. The coolant is returned from the coolant-LOHC_{Lean} return heat exchanger 178 via a coolant bypass return line 146 to the mixer 136 and combined with coolant utilized in the other heat exchangers. The combined coolant, which can be substantially liquid, is collected in a coolant reservoir 139 which serves as an coolant supply. The supply coolant is provided to the fuel cell 101 via the coolant supply line 122, which can include a coolant supply pump 123 or coolant supply electric heater 124. A direct supply valve 149 can be located between the mixer 136 and the coolant reservoir 139. When activated, the direct supply valve 149 can provide returned coolant directly to the fuel cell 101, which can be useful after the system is started when the supply line electric heater 124 is not being utilized.

The LOHC system 150 includes a dehydrogenation reactor 180 that receives LOHC_{Rich} via a LOHC_{Rich} supply line 152, which utilizes one or more LOHC supply pumps 153 to convey LOHC from a LOHC_{Rich} supply 151 to an LOHC_{Lean} return 159. The dehydrogenation reactor 180 extracts hydrogen from the LOHC_{Rich}, resulting in a mixture of hydrogen and LOHC_{Lean}. The mixture of hydrogen and LOHC_{Lean} is then sent through a LOHC_{Lean} outlet 157 to a hydrogen separator 112 to isolate hydrogen from LOHC_{Lean}. Hydrogen is delivered to the fuel cell 101 via a hydrogen supply line 110, which can include a purifier 118 en route. The LOHC_{Lean}, which is warm from the reactor, can be utilized in a LOHC_{Rich}-LOHC_{Lean} heat exchanger 170, to provide further pre-heating of the LOHC_{Rich} prior to its arrival at the subsequent coolant-LOHC heat exchangers. After the LOHC_{Rich}-LOHC_{Lean} heat exchanger 170, the LOHC_{Lean}is removed via a LOHC_{Lean} return line 158 which delivers the LOHC_{Lean} to a LOHC_{Lean} return 159 for storage in a reservoir or sent for rehydrogenation for regeneration of the LOHC_{Rich}. The LOHC system 150 includes a LOHC pre-heating stage 155 where the LOHC_{Rich} is heated prior to entering the dehydrogenation reactor. The LOHC pre-heating stage 155 includes one high-temperature coolant-LOHC heat exchanger 160. A secondary radiator 117 is used to dissipate excess heat from coolant post-reactor.

An example system (Example 2) was modeled based on a system architecture according to FIG. 3, using dodecahydro-N-ethylcarbazole/N-ethylcarbazole as a LOHC rich-lean pair. The modeled operation of the fuel cell power system, involves several assumptions and simplifications. The fuel cell power system incorporates one or more fuel cell stacks with a gross power output of 625.0 kW. It is assumed that the fuel cell stack has an overall efficiency of approximately 50% and operates at an average temperature of 180° C. Furthermore, no pressure drop within the coolant system has been considered. The efficiency of the dehydrogenation reaction is assumed to be 80%.

In Example 2, a fuel cell 101 operating at an average temperature of 180° C. incorporates a coolant system that employes refrigerant R718 (water) as the coolant. The cooling of the fuel cell 101 follows the “cooling through boiling” principle. The coolant enters the fuel cell 101 as supercooled liquid at a temperature and pressure of 175.0° C. and 10 bar, respectively, with 4.878° C. or supercooling. As the heat generated by the fuel cell 101 is transferred to the coolant, it gradually undergoes phase change before leaving the fuel cell 101 as superheated vapor at 185° C. with 5.122° C. of superheat. The net heat transferred to the coolant in the fuel cell 101 is 624.25 kW. After leaving the fuel cell 101, a portion of the coolant is transferred to a heat pump 135 where its temperature is increased to 275.1° C., corresponding to a temperature “lift” of 90.1° C. The pressure ratio across the heat pump is assumed to be 2.0. The power consumed by the heat pump 135 is 36.9 kW, assuming mechanical and electrical efficiencies of 85% and 95%, respectively. The remaining portion of the coolant is redirected to the primary radiator 116 (air-cooled) where it exchanges heat with the environment, with the ambient air acting as the final heat sink. The net heat dissipation from the primary radiator 116 into the ambient air is 212.66 kW. Since hydrogen lean N-ethylcarbazole is solid at room temperature (melting point 68-70° C.), a fraction of R718 that is routed to the primary radiator 116 is diverted to the LOHC_{Lean} return 159 to provide heat to keep the N-ethylcarbazole and the reaction intermediaries in the liquid phase for ease of ground handling and transportation. From the heat pump 135, the coolant is channeled to the pre-reactor coolant-LOHC_{Rich} heat exchanger 160 to preheat the hydrogen-rich dodecahydro-N-ethylcarbazole (the LOHC_{Rich}) from 119.815° C. to its final dehydrogenation temperature of the 180° C. The net heat transfer within the pre-reactor coolant-LOHC_{Rich} heat exchanger 160 is 33.5 kW. In the process, the temperature of the coolant reduces from 275.1° C. to 212.377° C. and its phase changes from superheated vapor to saturated vapor. After exiting the pre-reactor coolant-LOHC_{Rich}, heat exchanger 160, the coolant is transferred to the dehydrogenation reactor 180. Within the dehydrogenation reactor 180, while supplying the endothermic heat of dehydrogenation of 379.5 kW, the coolant progressively transitions from saturated vapor to saturated liquid phase. To ensure proper beat transfer between the LOHC_{Rich} and the coolant, a temperature difference of 32.377° C. is maintained throughout the dehydrogenation reaction. The coolant leaving the dehydrogenation reactor 180 is routed to the secondary radiator 117 (air-cooled) where it exchanges heat with the surrounding environment, with the ambient air acting as the final heat sink. The net heat dissipation from the secondary radiator 117 into the ambient air is 33.62 kW. During this, the temperature of the coolant reduces from 212.377° C. to 174.88° C. and its phase changes from saturated liquid to supercooled liquid with 37.5° C. supercooling. The supercooled coolant is then expanded and transferred to a mixer 136 where it merges with the coolant streams returning from the primary radiator 116 and from the LOHC_{Lean} return 159 before returning to the fuel cell 101.

The LOHC system 150 of Example 2 utilizes dehydrogenation of hydrogen-rich dodecahydro-N-ethylcarbazole (the LOHC_{Rich}) as a two-step process: preheating followed by dehydrogenation. The LOHC_{Rich} at 25° C. is first partially preheated to a temperature of 119.815° C. in the LOHC_{Rich}-LOHC_{Lean} heat exchanger 170 using the hot reaction products exiting the dehydrogenation reactor 180, and optionally with electric heater 172. The net heat transfer within the LOHC_{Rich}-LOHC_{Lean} heat exchanger 170 is 45.95 kW. From the LOHC_{Rich}-LOHC_{Lean} heat exchanger 170, dodecahydro-N-ethylcarbazole is routed to the pre-reactor coolant-LOHC_{Rich} heat exchanger 160, where it is preheated to its final dehydrogenation temperature of 180° C. and then sent to the dehydrogenation reactor 180. The net heat transfer within the pre-reactor coolant-LOHC_{Rich} heat exchanger 160 is 33.5 kW. In the reactor of Example 2, dodecahydro-N-ethylcarbazole is dehydrogenated in the presence of a catalyst. The dehydrogenation products, constituting of a mixture of liquid N-ethylcarbazole, various liquid dehydrogenation reaction intermediaries such as tetrahydro-N-ethylcarbazole and octahydro-N-ethylcarbazole, and gaseous hydrogen are first separated into liquid and gaseous constituents in the separator 112. The liquid constituents are recirculated through the LOHC_{Rich}-LOHC_{Lean} heat exchanger 170 before it is discharged into the LOHC_{Lean} return 159. The gaseous hydrogen is purified in the purifier 118 and routed to the fuel cell 101.

Example 2 differs from Example 1 in that the coolant circuit 120 in Example 2 includes a air-cooled secondary radiator 117 and eliminates the post-reactor coolant-LOHC_{Rich} heat exchanger 165. In Example 1, the post-reactor coolant-LOHC_{Rich} heat exchanger 165 is used to not only preheat the LOHC_{Rich}, but also to partially cool the coolant. Thus, no post-reactor coolant-LOHC_{Rich} heat exchanger 165 is included in that system. However, since the degree of supercooling in Example 1 is small, after expansion, the coolant enters the fuel cell 101 in a two-phase state. In Example 2, with the help of the air-cooled secondary radiator 117, the coolant is supercooled sufficiently to ensure that after expansion, it still remains in a liquid state and enters the fuel cell 101 as such. Thus, from the overall heat rejection perspective, Example 1 is more efficient than concept Example 2 in the sense that it dissipates less heat, 244.69 kW vs. 246.28 kW, respectively, into the environment. The difference in the dehydrogenation circuit of Example 2 is that the post-reactor coolant-LOHC_{Rich} heat exchanger 165 is no longer used to partially preheat the LOHC_{Rich}.

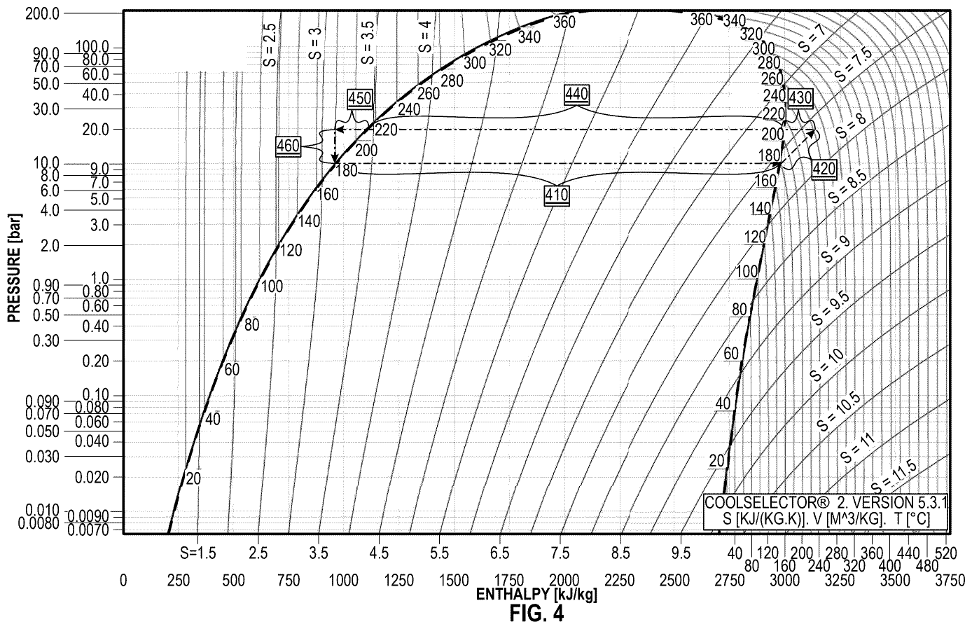

FIG. 4 provides a thermodynamic cycle diagram of the portion of the coolant circuit 120 of the system illustrated in FIG. 3 that transfers heat from the fuel cell 101 to the dehydrogenation reactor 180 and circulates the coolant back to the fuel cell 101. The fuel cell cooling branch 410 represents the process of coolant accepting heat from the fuel cell 101 at a coolant-fuel cell heat exchanger 107, which results in phase change of the coolant from liquid coolant to vapor coolant. The coolant leaves the fuel cell 101 and passes through a temperature lift stage 130 which includes a heat pump 135. The heat pump branch 420 represents a compression superheating process that serves to further heat the vaporized coolant. The superheated coolant is then passed through a heat exchanger at high temperature that interfaces the coolant circuit 120 with the LOHC system 150 at high temperature. The high temperature heat exchanger branch 430 represents transfer of sensible heat from the coolant to the LOHC_{Rich} in the LOHC pre-heating stage 155. Here, the vapor phase can be maintained. Then, the vapor phase coolant is provided to a heat exchanger in the dehydrogenation reactor 180. The dehydrogenation branch 440 represents the coolant-reactor heat exchanger 185, where the coolant dissipates its heat to facilitate the endothermic dehydrogenation process and in the processes condenses and delivers the latent heat captured from the fuel cell. After the dehydrogenation reactor 180, the coolant can be transmitted to a secondary radiator to facilitate heat dissipation which can represent an efficient means of heat dissipation with respect to the system overall. The secondary radiator branch 450 represents the isobaric heat dissipation of the secondary radiator. Lastly, the coolant is delivered to an expander 134 and then subsequently collected for recirculation to the fuel cell 101. The expansion branch 460 represents the expansion that completes the cycle.

FIG. 13 provides a schematic of a fuel cell system 100 in a third example, which involves a coolant circuit 120 having a temperature lift stage 130 and a LOHC system 150 having a LOHC pre-heating stage 155 with multiple heat exchangers utilizing heat from coolant at the temperature lift stage 130 upstream of a dehydrogenation reactor 180. The fuel cell system 100 includes a fuel cell stack 102, an anode 103, and a cathode 104. The fuel cell 101 utilizes hydrogen obtained from a hydrogen supply line 110 and an oxidant obtained from an oxidant supply system 105. The oxidant supply system 105 provides oxidant to the fuel cell 101 via an oxidant supply line 106. The operation of the fuel cell 101 generates electricity and thermal energy. The fuel cell 101 is cooled by the coolant circuit 120, which interfaces with the fuel cell 101 through a coolant-fuel cell heat exchanger 107. The coolant-fuel cell heat exchanger 107 transfers excess thenal energy generated by the fuel cell 101 via vaporization of the supplied coolant. The coolant circuit 120 utilizes one or more coolants, which can be optionally configured in one or more coolant loops, to capture latent heat from the fuel cell 101 and deliver the latent heat to the dehydrogenation reactor 180 of the LOHC system 150. In various aspects, the coolant is water. The coolant circuit 120 provides coolant to the fuel cell 101 via a coolant supply line 122. The coolant can be optionally heated via a coolant supply electric heater 124 to warm the coolant prior to delivery to the fuel cell 101. At the fuel cell, the coolant passes through a coolant-fuel cell heat exchanger 107 to absorb thermal waste, preferably vaporizing to provide a vapor phase coolant that is transferred away from the fuel cell 101 toward the dehydrogenation reactor 180 via a coolant return line 126. The coolant circuit 120 includes a temperature lift stage 130. As vapor phase coolant travels from the fuel cell 101 to the dehydrogenation reactor 180, the vapor phase coolant is passed through a temperature lift stage 130, which includes multiple heat pumps and an intervening pre-reactor coolant-LOHC_{Rich} heat exchanger 166 that serves as an intercooler. The temperature lift stage 130 includes a first heat pump 135, which heats vapor phase coolant which is then transmitted to the pre-reactor coolant-LOHC_{Rich} heat exchanger 166, which is a low temperature heat exchanger that serves to partially step up the temperature of the LOHC_{Rich} prior to its arrival at a higher-temperature heat exchanger, namely, the pre-reactor coolant-LOHC_{Rich} heat exchanger 160. The lower temperature pre-reactor coolant-LOHC_{Rich} heat exchanger 166 also serves as an intercooler between the first heat pump 135 and a second heat pump 137. After pass through the intercooler, the coolant is provided to the second heat pump 137. Use of a heat pump-intercooler-heat pump can serve to more efficiently superheat the coolant using readily-available heat pumps. Integration of a coolant circuit 120 and LOHC system 150 via the intercooler provides a further advantage of this configuration, as the sequential step-wise process for both super heating and LOHC pre-heating can be advantageous. After the second heat pump 137, the coolant is provided to a pre-reactor coolant-LOHC_{Rich} heat exchanger 160. This heat exchanger transfers heat away from the heated coolant to the LOHC_{Rich} ahead of the dehydrogenation reactor 180. The coolant is then transferred to the dehydrogenation reactor 180 via the coolant return line 126. The LOHC is transferred via the LOHC_{Rich} reactor inlet 156 to the dehydrogenation reactor 180. The dehydrogenation reactor 180 includes a coolant-reactor heat exchanger 185, which transfers heat from the coolant to the LOHC reaction mixture to facilitate dehydrogenation, which may optionally utilize a electric heater 182. The coolant undergoes phase change at the coolant-reactor heat exchanger 185 to transfer latent heat to the dehydrogenation reactor 180. The coolant is then conveyed away from the dehydrogenation reactor 180 for further heat dissipation at a secondary radiator 117. After the secondary radiator 117, the coolant is sent to an expander 134 and then subsequently collected for reuse in the coolant circuit 120. The cooled coolant is provided to a mixer 136, which collects coolant utilized in the various sinks. In various aspects, the coolant circuit is configured with configurable diversions via one or more flow diverter 129 or bypass valve 142. For example, a flow diverter 129 can be used to control how much heated coolant is sent to the dehydrogenation reactor 180 and how much is sent to one or more primary radiator 116. Further use of a bypass valve 142 after the flow diverter 129 can optionally be used to divert a portion of heated coolant to one or more storage reservoirs or component of the LOHC system. One or more functional valve 133 can be included to provide a control function. The bypass valve 142 diverts heated coolant to a coolant bypass supply line 144 that supplies a coolant-LOHC_{Lean} return heat exchanger 178 at the LOHC_{Lean} return 159 where LOHC_{Lean} is stored for removal for rehydrogenation. The coolant is returned from the coolant-LOHC_{Lean} return heat exchanger 178 via a coolant bypass return line 146 to the mixer 136 and combined with coolant utilized in the other heat exchangers. The combined coolant, which can be substantially liquid, is collected in a coolant reservoir 139 which serves as a coolant supply. The supply coolant is provided to the fuel cell 101 via the coolant supply line 122, which can include one or more coolant supply pump 123 or coolant supply electric heater 124. A direct supply valve 149 can be located between the mixer 136 and the coolant reservoir 139. When activated, the direct supply valve 149 can provide returned coolant directly to the fuel cell 101, which can be useful after the system is started when the supply line electric heater 124 is not being utilized.

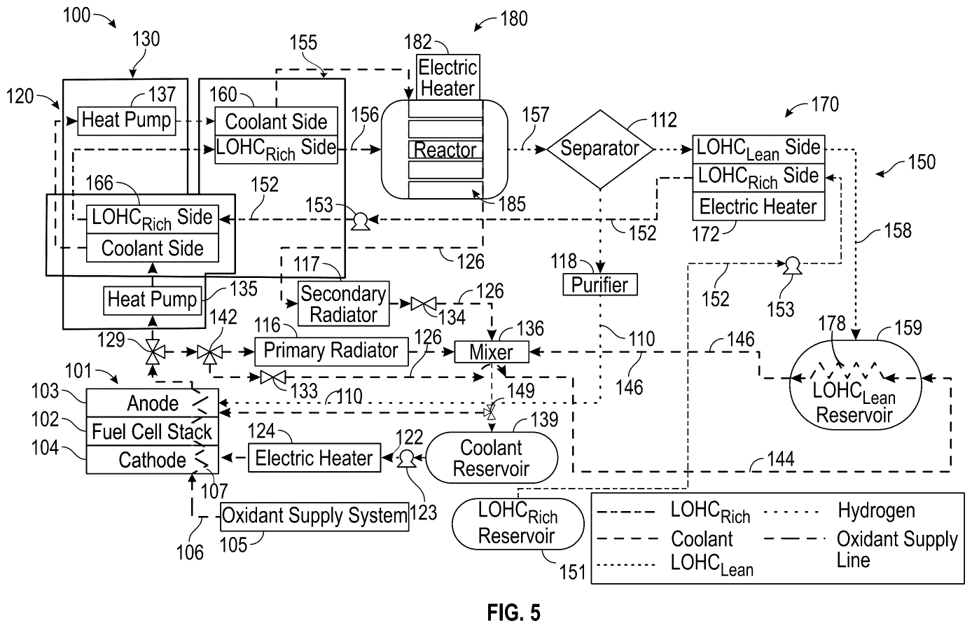

The LOHC system 150 includes a dehydrogenation reactor 180 that receives LOHC_{Rich} via a LOHC_{Rich} supply line 152, which utilizes one or more LOHC supply pumps 153 to convey LOHC from a LOHC_{Rich} supply 151 to an LOHC_{Lean} return 159. The dehydrogenation reactor 180 extracts hydrogen from the LOHC_{Rich}, resulting in a mixture of hydrogen and LOHC_{Lean}. The mixture of hydrogen and LOHC_{Lean} is then sent through a LOHC_{Lean} outlet 157 to a hydrogen separator 112 to isolate hydrogen from LOHC_{Lean}. Hydrogen is delivered to the fuel cell 101 via a hydrogen supply line 110, which can include a purifier 118 en route. The LOHC_{Lean}, which is warm from the dehydrogenation reactor 180, can be utilized in a LOHC_{Rich}-LOHC_{Lean} heat exchanger 170, to provide further pre-heating of the LOHC_{Rich}. After the LOHC_{Rich}-LOHC_{Lean} heat exchanger 170, the LOHC_{Lean} is removed via a LOHC_{Lean} return line 158 which delivers the LOHC_{Lean} to a LOHC_{Lean} return 159 for storage in a reservoir or sent for rehydrogenation for regeneration of the LOHC_{Rich}. The LOHC system 150 includes a LOHC pre-heating stage 155 where the LOHC_{Rich} is heated prior to entering the dehydrogenation reactor. The LOHC pre-heating stage 155 includes at least one higher-temperature coolant-LOHC heat exchanger, such as a pre-reactor coolant-LOHC_{Rich} heat exchanger 160, but can also include additional components for pre-heating the LOHC prior to its delivery to the dehydrogenation reactor 180. The system illustrated in FIG. 5, uses a two coolant-LOHC heat exchangers in the LOHC pre-heating stage 155: a pre-reactor coolant-LOHC_{Rich} heat exchanger 166, which serves as an intercooler, and a pre-reactor coolant-LOHC_{Rich} heat exchanger 160, which serves as the high-temperature heat exchanger. This system does not include a heat exchanger that utilizes the post-reactor coolant, and thus results in some excess heat prior to re-expansion which is dissipated by the secondary radiator 117. This configuration nonetheless allows for reduced size, bulk, or weight of the primary radiator and can also improve overall efficiency and performance of the fuel cell system.

An example system (Example 3) was modeled based on a system architecture according to FIG. 5, using dodecahydro-N-ethylcarbazole/N-ethylcarbazole as a LOHC rich-lean pair. The modeled operation of the fuel cell power system, involves several assumptions and simplifications. The fuel cell power system incorporates one or more fuel cell stacks with a gross power output of 625.0 kW. It is assumed that the fuel cell stack has an overall efficiency of approximately 50% and operates at an average temperature of 160° C., 20° C. below the dehydrogenation temperature of 180° C. Furthermore, no pressure drop within the coolant system has been considered. The efficiency of the dehydrogenation reaction is assumed to be 80%.

In Example 3, a fuel cell 101 operating at a temperature of 160° C. incorporates a coolant circuit 120 that employers refrigerant R718 (water) as the coolant. The cooling of the fuel cell 101 follows the “cooling through boiling” principle. The coolant enters the fuel cell 101 as wet vapor at a temperature and pressure of 158.826° C. and 6 bar, respectively, with 0.0981 quality. As the heat generated by the fuel cell 101 is transferred to the coolant, it gradually undergoes phase change before leaving the fuel cell 101 as superheated vapor at 165° C. with 6.174° C. of superheat. The net heat transferred to the coolant in the fuel cell 101 is 623.23 kW. After leaving the fuel cell 101, a portion of the coolant is transferred to a heat pump 135 where it is further superheated to a temperature of 240.9° C., corresponding to a temperature “lift” of 75.9° C. The pressure ratio across the heat pump is assumed to be 1.833. The power consumed by the heat pump 135 is 31.22 kV, assuming mechanical and electrical efficiencies of 85% and 95%, respectively. The remaining portion of the coolant is redirected to the primary radiator 116 (air-cooled) where it exchanges heat with the environment, with the ambient air acting as the final heat sink. The net heat dissipation from the primary radiator 116 into the ambient air is 242.47 kW. Since hydrogen lean N-ethylcarbazole is solid at room temperature (melting point 68-70° C.), a fraction of the coolant that is routed to the primary radiator 116 is diverted to the LOHC_{Lean} return 159 to provide the heat to keep the N-ethylcarbazole and the reaction intermediaries in the liquid phase for ease of ground handling and transportation. The coolant exiting the first heat pump 135 is then passed through a first pre-reactor coolant-LOHC_{Rich} heat exchanger 166 that serves as an intercooler to further preheat the LOHC_{Rich}, while the coolant cools down to a temperature of 190.0° C. with 5.938° C. of superheat. The net heat dissipation from the intercooler 138 into the ambient air is 24.5 kW. From the first pre-reactor coolant-LOHC_{Rich} heat exchanger 166, the coolant is transferred to a second heat pump 137 where it is again superheated to a temperature of 267.33° C., corresponding to a temperature lift of 77.3° C. The pressure ratio across the heat pump is assumed to be 1.818. The power consumed by the second beat pump 137 is 31.7 kW, assuming mechanical and electrical efficiencies of 85% and 95%, respectively. From the second heat pump 137, the coolant is channeled to pre-reactor coolant-LOHC_{Rich} heat exchanger 160 to preheat the LOHC_{Rich} to its final dehydrogenation temperature of 180° C. The net heat transfer within the pre-reactor coolant-LOHC_{Rich} heat exchanger 160 is 29.77 kA. In the process, the temperature of the coolant decreases from 267.33° C. to 212.377° C. and its phase changes from superheated vapor to saturated vapor. After exiting the high temperature heat exchanger, the coolant is transferred to the dehydrogenation reactor 180. Within the dehydrogenation reactor 180, while supplying endothermic heat of dehydrogenation of 379.5 kW, the coolant progressively transitions from saturated vapor to saturated liquid phase. To ensure proper heat transfer between the LOHC_{Rich} and the coolant, a temperature difference of 32.377° C. is maintained throughout the dehydrogenation reaction. The coolant leaving the dehydrogenation reactor 180 is then routed to a secondary radiator 117 where it exchanges heat with the surrounding environment with ambient air acting as the final heat sink. During this, the temperature of the coolant reduces from 212.377° C. to 205° C. and its phase changes from saturated liquid to supercooled liquid with 7.377° C. supercooling. The net heat transfer at the secondary radiator 117 is 11.0 kW. The supercooled coolant is then expanded and transferred to a mixer 136 where it merges with the coolant streams returning from the primary radiator 116 and the LOHC_{Lean} return 159 before it is returned to the fuel cell.

The LOHC system 150 of Example 3 utilizes dehydrogenation of hydrogen rich dodecahydro-N-ethylcarbazole as a two-step process: preheating followed by dehydrogenation. The LOHC_{Rich} at 25° C. is first partially preheated to a temperature of 79.0° C. in the LOHC_{Rich}-LOHC_{Lean} heat exchanger 170 using the hot reaction products exiting the dehydrogenation reactor, and optionally with electric heater 172. The net heat transfer within the LOHC_{Rich}-LOHC_{Lean} heat exchanger 170 is 25.14 kW. From the LOHC_{Rich}-LOHC_{Lean} heat exchanger 170, dodecahydro-N-ethylcarbazole is routed to a first pre-reactor coolant-LOHC_{Rich} heat exchanger 166 that serves as an intercooler where it is further heated to a temperature of 126.87° C. before it is transferred to the second pre-reactor coolant-LOHC_{Rich} heat exchanger 160. The net heat transfer within the first pre-reactor coolant-LOHC_{Rich} heat exchanger 166 is 24.5 kW. In the second pre-reactor coolant-LOHC_{Rich} heat exchanger 160, dodecahydro-N-ethylcarbazole is preheated to its final dehydrogenation temperature of 180° C. and then sent to the dehydrogenation reactor 180. The net heat transfer within the pre-reactor coolant-LOHC_{Rich} heat exchanger 160 is 29.77 kW. In the reactor of Example 4, dodecahydro-N-ethylcarbazole is dehydrogenated in the presence of a catalyst. The dehydrogenation products, constituting of a mixture of liquid N-ethylcarbazole, various liquid dehydrogenation reaction intermediaries such as tetrahydro-N-ethylcarbazole and octahydro-N-ethylcarbazole, and gaseous hydrogen are first separated into liquid and gaseous constituents in the separator 112. The liquid constituents are recirculated through the LOHC_{Rich}-LOHC_{Lean} heat exchanger 170 before it is discharged into the LOHC_{Lean} return 159. The gaseous hydrogen is purified in the purifier 118 and then routed to the fuel cell 101.

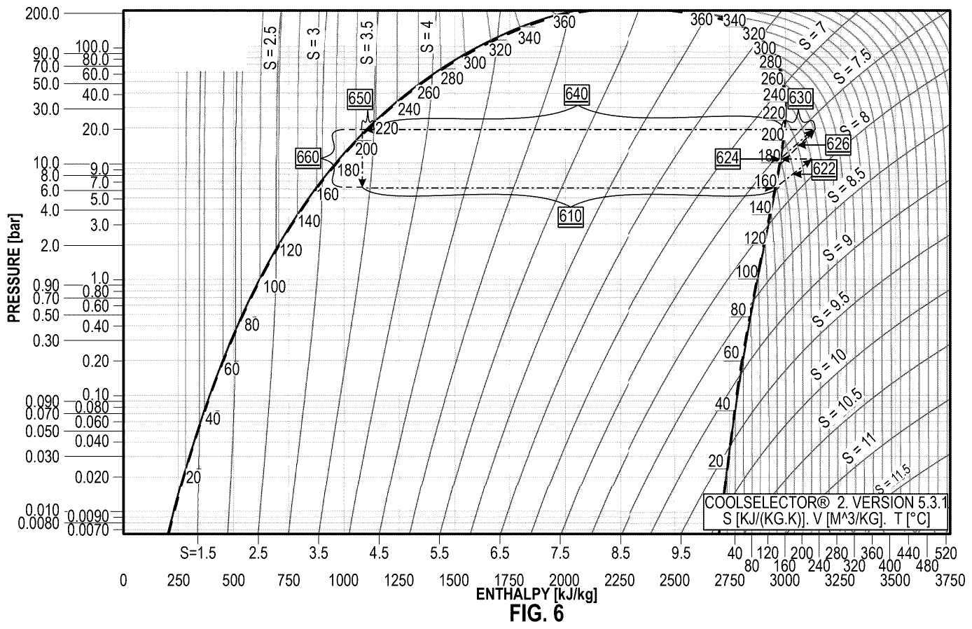

FIG. 6 provides a thermodynamic cycle diagram of the portion of the coolant circuit 120 of the system illustrated in FIG. 5 that transfers heat from the fuel cell 101 to the dehydrogenation reactor 180 and circulates the coolant back to the fuel cell 101. The fuel cell cooling branch 610 represents the process of coolant accepting heat from the fuel cell 101 at a coolant-fuel cell heat exchanger 107, which results in phase change of the coolant from liquid coolant to vapor coolant. The coolant leaves the fuel cell 101 and passed through a temperature lift stage 130 which includes multiple heat pumps and with an intervening intercooler. The heat pump branch 620 (represented by superheating step 622, intermediate cooling step 624, superheating step 626) represents a sequential, stepwise compression superheating process that serves to efficiently heat the vaporized coolant. The use of a first heat pump 135 provides a superheating step 622, followed by a pre-reactor coolant-LOHC_{Rich} heat exchanger 166 that serves as an intercooler that provides an intermediate cooling step 624, followed by an additional heat pump 137 that provides a superheating step 626, which together facilitates use of cost-effective and readily-available heat pumps to provide a significant lift. The superheated coolant is then passed through a heat exchanger at high temperature that interfaces the coolant circuit with the LOHC system at high temperature. The high temperature heat exchanger branch 630 represents transfer of sensible heat from the coolant to the LOHC_{Rich} in the LOHC pre-heating stage 155. Here, the vapor phase can be maintained. Then, the vapor phase coolant is provided to a heat exchanger in the dehydrogenation reactor 180. The dehydrogenation branch 640 represents the coolant-reactor heat exchanger 185, where the coolant dissipates its heat to facilitate the endothermic dehydrogenation process and in the processes condenses and delivers the latent heat captured from the fuel cell. After the dehydrogenation reactor 180, the coolant can be transmitted to a secondary radiator to facilitate heat dissipation which can represent an efficient means of heat dissipation with respect to the system overall. The secondary radiator branch 650 represents the isobaric heat dissipation of the secondary radiator. Lastly, the coolant is delivered to an expander 134 and then subsequently collected for recirculation to the fuel cell 101. The branch 660 represents the expansion that completes the cycle.

FIG. 14 provides a schematic of a fuel cell system 100 in a fourth example, which involves a coolant circuit 120 having a temperature lift stage 130 having multiple heat pumps, and a LOHC system 150 having a LOHC pre-heating stage 155 with heat exchangers utilizing a heat from coolant both upstream and downstream of a dehydrogenation reactor 180. The fuel cell 101 includes a fuel cell stack 102, an anode 103, and a cathode 104. The fuel cell 101 utilizes hydrogen obtained from a hydrogen supply line 110 and an oxidant obtained from an oxidant supply system 105. The oxidant supply system 105 provides oxidant to the fuel cell 101 via an oxidant supply line 106. The operation of the fuel cell 101 generates electricity and thermal energy. The fuel cell 101 is cooled by the coolant circuit 120, which interfaces with the fuel cell 101 through a coolant-fuel cell heat exchanger 107. The coolant-fuel cell heat exchanger 107 transfers excess thermal energy generated by the fuel cell 101 via vaporization of the supplied coolant. The coolant circuit 120 utilizes one or more coolants, which can be optionally configured in one or more coolant loops, to capture latent heat from the fuel cell 101 and deliver the latent heat to the dehydrogenation reactor 180 of the LOHC system 150. In various aspects, the coolant is water. The coolant circuit 120 provides coolant to the fuel cell 101 via a coolant supply line 122. The supplied coolant is liquid phase coolant. The coolant can be optionally heated via a coolant supply electric heater 124 to warm the liquid phase prior to delivery to the fuel cell 101. At the fuel cell, the coolant passes through a coolant-fuel cell heat exchanger 107 to absorb thermal waste, preferably vaporizing to provide a vapor phase coolant that is transferred away from the fuel cell 101 toward the dehydrogenation reactor 180 via a coolant return line 126. The coolant circuit 120 includes a temperature lift stage 130. As vapor phase coolant travels from the fuel cell 101 to the dehydrogenation reactor 180, the vapor phase coolant is passed through a temperature lift stage 130, which includes a first heat pump 135, an intercooler 138, and a second heat pump 137. The first heat pump 135 heats the vapor phase coolant which is then transmitted to an intercooler 138 before traveling to a second beat pump 137. Use of a beat pump-intercooler-heat pump arrangement can serve to more efficiently superheat the coolant using readily-available heat pumps. After the second heat pump 137, the coolant is provided to a pre-reactor coolant-LOHC_{Rich} heat exchanger 160. This heat exchanger transfers heat away from the heated coolant to the LOHC_{Rich} ahead of the dehydrogenation reactor 180. The coolant is then transferred to the dehydrogenation reactor 180 via the coolant return line 126. The LOHC is transferred via the LOHC_{Rich} reactor inlet 156 to the dehydrogenation reactor 180. The dehydrogenation reactor 180 includes a coolant-reactor heat exchanger 185, which transfers heat from the coolant to the LOHC reaction mixture to facilitate dehydrogenation, which may optionally utilize a reactor electric heater 182. The coolant undergoes phase change at the coolant-reactor heat exchanger 185 to transfer latent heat to the dehydrogenation reactor 180. The coolant is then conveyed away from the dehydrogenation reactor 180 to a post-reactor coolant-LOHC_{Rich} heat exchanger 165. The post-reactor coolant-LOHC_{Rich} heat exchanger 165 can be configured as a low-temperature heat exchanging that serves to partially heat the LOHC_{Rich} prior to the pre-reactor coolant-LOHC_{Rich} heat exchanger 160 and dehydrogenation reactor 180. After the post-reactor coolant-LOHC_{Rich} heat exchanger 165, the coolant is sent to an expander 134 and then subsequently collected for reuse in the coolant circuit 120. The cooled coolant is provided to a mixer 136, which collects coolant dissipated at other sinks such as radiators or storage reservoirs. The coolant circuit 120 dissipates heat from the fuel cell 101 at the dehydrogenation reactor 180, but it also will typically dissipate heat at one or more primary radiator 116 or other substantial sinks. In various aspects, the coolant circuit is configured with configurable diversions via one or more flow diverter 129 or bypass valve 142. For example, a flow diverter 129 can be used to control how much heated coolant is sent to the dehydrogenation reactor 180 and how much is sent to one or more primary radiator 116. Further use of a bypass valve 142 after the flow diverter 129 can optionally be used to divert a portion of heated coolant to one or more storage reservoirs or component of the LOHC system. One or more functional valve 133 can be included to provide a control function. The bypass valve 142 diverts heated coolant to a coolant bypass supply line 144 that supplies a coolant-LOHC_{Lean} return heat exchanger 178 at the LOHC_{Lean} return 159 where LOHC_{Lean} is stored for removal for rehydrogenation. The coolant is returned from the coolant-LOHC_{Lean} return heat exchanger 178 via a coolant bypass return line 146 to the mixer 136 and combined with coolant utilized in the other heat exchangers. The combined coolant, which can be substantially liquid, is collected in a coolant reservoir 139 which serves as a coolant supply. The supply coolant is provided to the fuel cell 101 via the coolant supply line 122, which can include one or more coolant supply pump 123 or coolant supply electric heater 124. A direct supply valve 149 can be located between the mixer 136 and the coolant reservoir 139. When activated, the direct supply valve 149 can provide returned coolant directly to the fuel cell 101, which can be useful after the system is started when the supply line electric heater 124 is not being utilized.

The LOHC system 150 includes a dehydrogenation reactor 180 that receives LOHC_{Rich} via a LOHC_{Rich} supply line 152, which utilizes one or more LOHC supply pumps 153 to convey LOHC from a LOHC_{Rich} supply 151 to an LOHC_{Lean} return 159. The dehydrogenation reactor 180 extracts hydrogen from the LOHC_{Rich}, resulting in a mixture of hydrogen and LOHC_{Lean}. The mixture of hydrogen and LOHC_{Lean} is then sent through a LOHC_{Lean} outlet 157 to a hydrogen separator 112 to isolate hydrogen from LOHC_{Lean}. Hydrogen is delivered to the fuel cell 101 via a hydrogen supply line 110 passing through a purifier 118 en route. The LOHC_{Lean}, which is warm from the reactor, can be utilized in a LOHC_{Rich}-LOHC_{Lean} heat exchanger 170, to provide further pre-heating of the LOHC_{Rich} prior to its arrival at the subsequent coolant-LOHC heat exchangers. After the LOHC_{Rich}-LOHC_{Lean} heat exchanger 170, the LOHC_{Lean} is removed via a LOHC_{Lean} return line 158 which delivers the LOHC_{Lean} to a LOHC_{Lean} return 159 for storage in a reservoir or sent for rehydrogenation for regeneration of the LOHC_{Rich}.

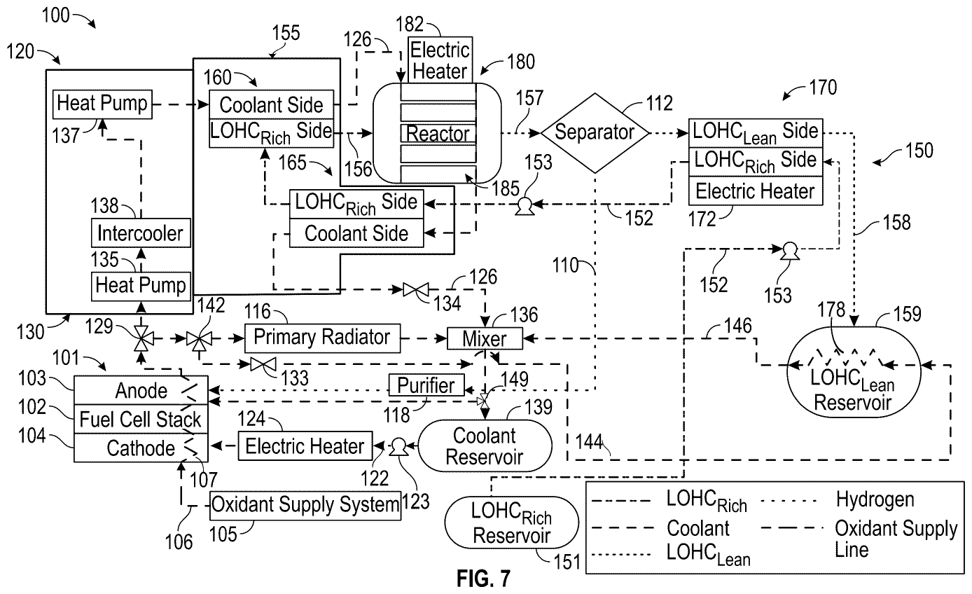

The LOHC system 150 includes a LOHC pre-heating stage 155 where the LOHC_{Rich} is heated prior to entering the dehydrogenation reactor. This pre-heating can be achieved by using one or more heat exchangers, which can interface with the coolant circuit either before or after circulation of the coolant through the dehydrogenation reactor. In FIG. 7, the LOHC pre-heating stage 155 utilizes a post-reactor coolant-LOHC_{Rich} heat exchanger 165, which serves as a first lower temperature heat exchanger, and a pre-reactor coolant-LOHC_{Rich} heat exchanger 160, which serves as a second higher temperature heat exchanger that heats a higher temperature at or near the dehydrogenation reactor operation temperature. The LOHC system 150 is integrated with the coolant circuit 120 by interfacing at or following the temperature lift stage 130 where super heating is achieved via a stepwise heat pump-intercooler-heat pump processes. Such configuration can permit efficient dissipation of latent heat from the fuel cell 101 to the dehydrogenation reactor 180, while still permit efficient transfer of sensible heat from the temperature lift stage 130 to the LOHC pre-heating stage 155. This integration allows for reduced size, bulk, or weight of primary radiators or other auxiliary heat dissipation sinks, and can improve overall efficiency and performance of the fuel cell system.

An example system (Example 4) was modeled based on a system architecture according to FIG. 7, using dodecahydro-N-ethylcarbazole/N-ethylcarbazole as a LOHC rich-lean pair. The modeled operation of the fuel cell power system, involves several assumptions and simplifications. The fuel cell power system incorporates one or more fuel cell stacks with a gross power output of 625.0 kW. It is assumed that the fuel cell stack has an overall efficiency of approximately 50% and operates at an average temperature of 160° C., 20° C. below the dehydrogenation temperature of 180° C. Furthermore, no pressure drop within the coolant system has been considered. The efficiency of the dehydrogenation reaction is assumed to be 80%.

In Example 4, a fuel cell 101 operating at a temperature of 160° C. incorporates a coolant circuit 120 that employes refrigerant R718 (water) as the coolant. The cooling of the fuel cell 101 follows the “cooling through boiling” principle. The coolant enters the fuel cell 101 as wet vapor at a temperature and pressure of 158.826° C. and 6 bar, respectively, with 0.1014 quality. As the heat generated by the fuel cell 101 is transferred to the coolant, it gradually undergoes phase change before leaving the fuel cell 101 as superheated vapor at 165° C. with 6.174° C. of superheat. The net heat transferred to the coolant in the fuel cell 101 is 623.23 kW. After leaving the fuel cell 101, a portion of the coolant is transferred to a heat pump 135 where it is further superheated to a temperature of 240.9° C., corresponding to a temperature “lift” of 75.9° C. The pressure ratio across the heat pump is assumed to be 1.833. The power consumed by the heat pump 135 is 31.22 kW, assuming mechanical and electrical efficiencies of 85% and 95%, respectively. The remaining portion of the coolant is redirected to the primary radiator 116 (air-cooled) where it exchanges heat with the environment, with the ambient air acting as the final heat sink. The net heat dissipation from the primary radiator 116 into the ambient air is 243.85 kW. Since hydrogen lean N-ethylcarbazole is solid at room temperature (melting point 68-70° C.), a fraction of the coolant that is routed to the primary radiator 116 is diverted to the LOHC_{Lean} return 159 to provide heat to keep the N-ethylcarbazole and the reaction intermediaries in the liquid phase for ease of ground handling and transportation. The coolant exiting the first heat pump 135 is then passed through an intercooler 138 (air-cooled) where it is cooled down to a temperature of 190.0° C. while still retaining 5.938° C. of superheat. The net heat dissipation from the intercooler 138 into the ambient air is 24.5 kW. From the intercooler 138, the coolant is transferred to a second heat pump 137 where it is again superheated to a temperature of 267.33° C., corresponding to a temperature lift of 77.3° C. The pressure ratio across the second heat pump is assumed to be 1.818. The power consumed by the second heat pump 137 is 31.7 kW, assuming mechanical and electrical efficiencies of 85% and 95%, respectively. From the second heat pump 137, the coolant is channeled to the pre-reactor coolant-LOHC_{Rich} heat exchanger 160 to preheat the LOHC_{Rich} to its final dehydrogenation temperature of the 180° C. The net heat transfer within the pre-reactor coolant-LOHC_{Rich} heat exchanger 160 is 29.77 kW. In the process, the temperature of the coolant decreases from 267.33° C. to 212.377° C. and its phase changes from superheated vapor to saturated vapor. After exiting the high temperature heat exchanger, the coolant is transferred to the dehydrogenation reactor 180. Within the dehydrogenation reactor 180, while supplying endothermic heat of dehydrogenation of 379.5 kW, the coolant progressively transitions from saturated vapor to saturated liquid phase. To ensure proper heat transfer between the LOHC_{Rich} and coolant, a temperature difference of 32.377° C. is maintained within the dehydrogenation reactor. The coolant leaving the dehydrogenation reactor 180 is then routed to the post-reactor coolant-LOHC_{Rich} heat exchanger 165 to further preheat the LOHC_{Rich}. In the process, the temperature of the coolant decreases from 212.377° C. to 206.53° C. and its phase changes from saturated liquid to supercooled liquid with 5.85° C. of supercooling. The net heat transfer within the post-reactor coolant-LOHC_{Rich} heat exchanger 165 is 5.34 kW. The supercooled coolant is then expanded and transferred to a mixer 136 where it merges with the coolant streams returning from the primary radiator 116 and from the LOHC_{Lean} return 159 before it is returned to the fuel cell 101. The LOHC system 150 of Example 4 utilizes dehydrogenation of hydrogen-rich dodecahydro-N-ethylcarbazole (the LOHC_{Rich}) as a two-step process: preheating followed by dehydrogenation. The LOHC_{Rich} at 25° C., is first partially preheated to a temperature of 116.818 CC in the LOHC_{Rich}-LOHC_{Lean} heat exchanger 170 using the hot reaction products exiting the dehydrogenation reactor, and optionally with electric heater 172. The net heat transfer within the LOHC_{Rich}-LOHC_{Lean} heat exchanger 170 is 44.37 kW. From the LOHC_{Rich}-LOHC_{Lean} heat exchanger 170, dodecahydro-N-ethylcarbazole is routed to the post-reactor coolant-LOHC_{Rich} heat exchanger 165 where it is further heated to a temperature of 126.87° C. before it is transferred to the pre-reactor coolant-LOHC_{Rich} heat exchanger 160. The net heat transfer within the post-reactor coolant-LOHC_{Rich} heat exchanger 170 is 5.34 kW. In the pre-reactor coolant-LOHC_{Rich} heat exchanger 160, dodecahydro-N-ethylcarbazole is preheated to its final dehydrogenation temperature of 180° C. and then sent to the dehydrogenation reactor 180. The net heat transfer within the pre-reactor coolant-LOHC_{Rich} heat exchanger 160 is 29.77 kW. In the reactor of Example 4, dodecahydro-N-ethylcarbazole is dehydrogenated in the presence of a catalyst. The dehydrogenation products, constituting of a mixture of liquid N-ethylcarbazole, various liquid dehydrogenation reaction intermediaries such as tetrahydro-N-ethylcarbazole and octahydro-N-ethylcarbazole, and gaseous hydrogen are first separated into liquid and gaseous constituents in the separator 112. The liquid constituents are recirculated through the LOHC_{Rich}-LOHC_{Lean} heat exchanger 170 before it is discharged into the LOHC_{Lean} return 159. The gaseous hydrogen is purified in the purifier 118 and then routed to the fuel cell 101.

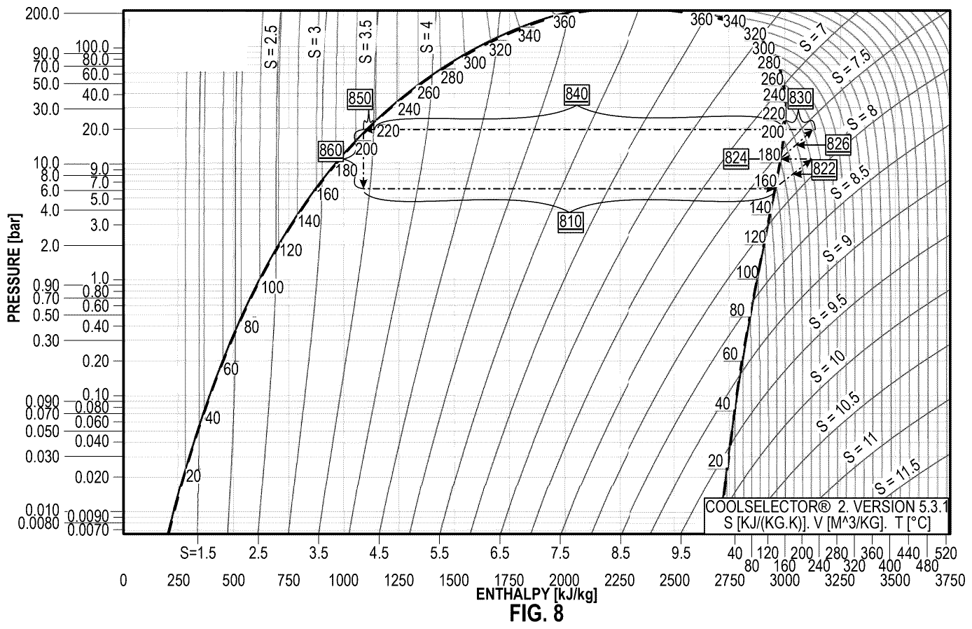

FIG. 8 provides a thermodynamic cycle diagram of the portion of the coolant circuit 120 of the system illustrated in FIG. 7 that transfers heat from the fuel cell 101 to the dehydrogenation reactor 180 and circulates the coolant back to the fuel cell 101. The fuel cell cooling branch 810 represents the process of coolant accepting heat from the fuel cell 101 at a coolant-fuel cell heat exchanger 107, which results in phase change of the coolant from liquid coolant to vapor coolant. The coolant leaves the fuel cell 101 and passed through a temperature lift stage 130 which includes multiple heat pumps and with an intervening intercooler. The heat pump branch 820 (represented by superheating step 822, intermediate cooling step 824, superheating step 826) represents a sequential, stepwise compression superheating process that serves to efficiently heat the vaporized coolant. The use of a first heat pump 135 provides a superheating step 822, followed by an intercooler 138 that provides an intermediate cooling step 824 before the next compression, followed by an additional heat pump 137 that provides a superheating step 826, which together facilitates use of cost-effective and readily-available heat pumps to provide a significant lift. The superheated coolant is then passed through a heat exchanger at high temperature that interfaces the coolant circuit with the LOHC system at high temperature. The high temperature heat exchanger branch 830 represents transfer of sensible heat from the coolant to the LOHC_{Rich} in the LOHC pre-heating stage 155. Here, the vapor phase can be maintained. Then, the vapor phase coolant is provided to a heat exchanger in the dehydrogenation reactor 180. The dehydrogenation branch 840 represents the coolant-reactor heat exchanger 185, where the coolant dissipates its heat to facilitate the endothermic dehydrogenation process and in the processes condenses and delivers the latent heat captured from the fuel cell. After the dehydrogenation reactor 180, the coolant can be transmitted to a lower temperature heat exchanger for heating LOHC in the LOHC system. The low temperature heat exchanger branch 850 represents the isobaric heat dissipation of the post-reactor coolant-LOHC_{Rich} heat exchanger 165. Lastly, the coolant is delivered to an expander 134 and then subsequently collected for recirculation to the fuel cell 101. The expansion branch 860 represents the expansion that completes the cycle.

Examples 3 and 1 have similar thermodynamic cycles and differ in how the heat within the system is used for preheating the LOHC_{Rich}. In Example 3, the heat rejection from the pre-reactor coolant-LOHC_{Rich} heat exchanger 166 is used to partially preheat the LOHC_{Rich}, while in Example 4 the post-reactor coolant-LOHC_{Rich} heat exchanger 165 serves that purpose. In Example 3, a relatively small air-cooled secondary radiator 117 is used, while in Example 4, a comparatively large, air-cooled intercooler 138 is used. Consequently, Example 3 is more efficient than Example 4 from the perspective of heat rejection, which is 253.47 kW vs. 268.35 kW, respectively.

FIG. 15 provides a schematic of a fuel cell system 100 in a fifth example, which involves a coolant circuit 120 having multiple coolant loops, a temperature lift stage 130, a single coolant-LOHC heat exchanger.

The fuel cell 101 includes a fuel cell stack 102, an anode 103, and a cathode 104. The fuel cell 101 utilizes hydrogen obtained from a hydrogen supply line 110 and an oxidant obtained from an oxidant supply system 105. The oxidant supply system 105 provides oxidant to the fuel cell 101 via an oxidant supply line 106. The operation of the fuel cell 101 generates electricity and thermal energy. The fuel cell 101 is cooled by a first coolant in a first coolant loop 190 of the coolant circuit 120. The first coolant loop 190 interfaces with the fuel cell 101 through a coolant-fuel cell heat exchanger 107. The coolant-fuel cell heat exchanger 107 transfers excess thermal energy generated by the fuel cell 101 via vaporization of the supplied coolant. The first coolant loop 190 captures heat from the fuel cell 101 and delivers it to a second coolant loop 195. The second coolant loop 195 delivers the latent heat to the dehydrogenation reactor 180 of the LOHC system 150. The first coolant loop 190 provides coolant to the fuel cell 101 via a first coolant supply line 191. The coolant can be optionally heated via a coolant supply electric heater 124 to warm the liquid phase prior to delivery to the fuel cell 101. At the fuel cell, the coolant passes through a coolant-fuel cell heat exchanger 107 to absorb thermal waste, that is transferred away from the fuel cell 101 toward a first coolant-second coolant beat exchanger 194, which transfers the heat from the first coolant loop 190 to the second coolant loop 195. From the first coolant-second coolant heat exchanger 194, the first coolant is conveyed through the first coolant return line 192 to the first coolant reservoir 139, from which the first coolant can be recirculated to the fuel cell 101 via a coolant supply pump 123 and electric heater 124.

The second coolant loop 195 includes a temperature lift stage 130. As vapor phase coolant travels from first coolant-second coolant heat exchanger 194 toward the dehydrogenation reactor 180 via a second coolant line 196, the vapor phase coolant is passed through a temperature lift stage 130, which includes a first heat pump 135, an intercooler 138, and a second heat pump 137. The first beat pump 135 superheats the vapor phase coolant which is then transmitted to an intercooler 138 before traveling to a second heat pump 137. After the second heat pump 137, the coolant is provided to a pre-reactor coolant-LOHC_{Rich} heat exchanger 160. This heat exchanger transfers heat away from the heated coolant to the LOHC_{Rich} ahead of the dehydrogenation reactor 180. The coolant is then transferred to a pre-reactor coolant-hydrogen heat exchanger 169. The LOHC is transferred via the LOHC_{Rich} reactor inlet 156 to the dehydrogenation reactor 180. The pre-reactor coolant-hydrogen heat exchanger 169, which operates at a high temperature near that of the dehydrogenation reactor, raises hydrogen to a target temperature for use in the fuel cell 101, while permitting the second coolant to remain in the vapor phase at the target temperature when subsequently transferred to the dehydrogenation reactor 180. The dehydrogenation reactor 180 includes a coolant-reactor heat exchanger 185, which transfers heat from the coolant to the LOHC reaction mixture to facilitate dehydrogenation, which may optionally utilize a reactor electric heater 182. The coolant undergoes phase change at the coolant-reactor heat exchanger 185 to transfer latent heat to the dehydrogenation reactor 180. The coolant is then conveyed away from the dehydrogenation reactor 180 to a secondary radiator 117. The coolant is then passed through expander 134 to a second coolant reservoir 193, and then returned to the first coolant-second coolant heat exchanger 194 via the second coolant line 196.

The LOHC system 150 includes a dehydrogenation reactor 180 that receives LOHC_{Rich} via a LOHC_{Rich} supply line 152, which utilizes one or more LOHC supply pumps 153 to convey LOHC from a LOHC_{Rich} supply 151 to an LOHC_{Lean} return 159. The dehydrogenation reactor 180 extracts hydrogen from the LOHC_{Rich}, resulting in a mixture of hydrogen and LOHC_{Lean}. The mixture of hydrogen and LOHC_{Lean}, which is warm from the reactor, is sent to a LOHC_{Rich}-LOHC_{Lean} heat exchanger 170, to provide further pre-heating of the LOHC_{Rich} prior to its arrival at the subsequent coolant-LOHC heat exchangers. After the LOHC_{Rich}-LOHC_{Lean} heat exchanger 170, the mixture of hydrogen and LOHC_{Lean} is then sent through a LOHC_{Lean} outlet 157 to a hydrogen separator 112 to isolate hydrogen from the LOHC_{Lean}. The separated hydrogen is processed through a hydrogen purifier 118, and then passed through a pre-reactor coolant-hydrogen heat exchanger 169 to heat up the hydrogen before being delivered to the fuel cell 101 via hydrogen supply line 110, which can include a purifier 118 en route. The separated LOHC_{Lean} is removed via a LOHC_{Lea}n return line 158 which delivers the LOHC_{Lean} to a LOHC_{Lean} return 159 for storage in a reservoir or sent for rehydrogenation for regeneration of the LOHC_{Rich}. The LOHC system 150 includes a LOHC pre-heating stage 155 where the LOHC_{Rich} is heated prior to entering the dehydrogenation reactor 180. The LOHC pre-heating stage 155 illustrated here includes the high-temperature coolant-LOHC heat exchanger 160.

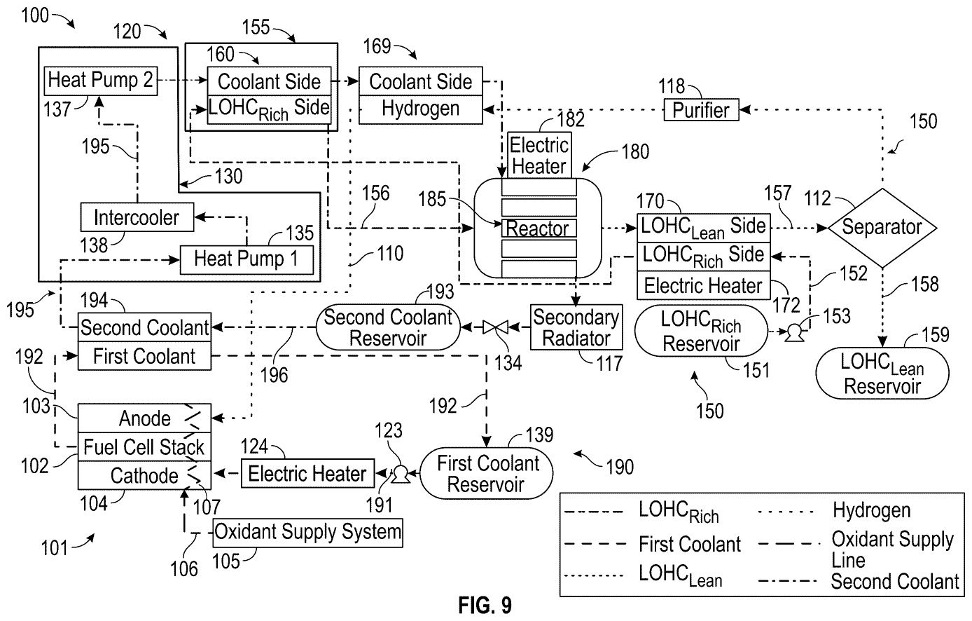

An example system (Example 5) was modeled based on a system architecture according to FIG. 9, using methylcyclohexane/toluene as a LOHC rich-lean pair. The modeled operation of the fuel cell power system, involves several assumptions and simplifications. The fuel cell power system incorporates one or more fuel cell stacks with a gross power output of 625.0 kW. It is assumed that the fuel cell stack has an overall efficiency of approximately 50% and operates at an average temperature of 240° C., 10° C. below the dehydrogenation temperature of 250° C. Furthermore, no pressure drop within the coolant system has been considered. The efficiency of the dehydrogenation reaction is assumed to be 80%. Also, no assumption has been made regarding the operating pressure of the stack or the stack coolant system and the type of cooling medium. A feature of this configuration is that the heat carried away by the coolant from the fuel cell 101, is first transferred to another coolant which is subsequently transferred to the dehydrogenation reactor 180.

In Example 5, a fuel cell 101 operating at a temperature of 240° C. incorporates a coolant circuit 120. The coolant leaving the fuel cell 101 is routed to a first coolant-second coolant heat exchanger 194 where it transfers the heat from the first coolant to the second coolant, and the first coolant is subsequently returned to the fuel cell 101. The net heat transfer in the first coolant-second coolant heat exchanger is 627.24 kW. The second coolant enters the first coolant-second coolant heat exchanger 194 as supercooled liquid at a temperature and pressure of 210.73° C. and 20 bar, respectively, with 2.377° C. of supercooling. As the heat carried by the first coolant is transferred to the second coolant, it gradually undergoes phase change before leaving the first coolant-second coolant heat exchanger 194 as superheated vapor at 215.0° C. with 2.623° C. of superheat. After leaving the first coolant-second coolant heat exchanger 194, the coolant is routed to the first heat pump 135 where it is further superheated to a temperature of 288.53° C., corresponding to a temperature “lift” of 73.53° C. The pressure ratio across the first heat pump 135 is assumed to be 1.75. The power consumed by the first heat pump 135 is 48.73 kW, assuming mechanical and electrical efficiencies of 85% and 95%, respectively. The coolant exiting the first heat pump 135 is then passed through an intercooler 138 (air-cooled) where it is cooled down to a temperature of 245° C. while still retaining 2.443° C. of superheat. The net heat dissipation from the intercooler 138 into the ambient air is 44.6 kW. From the intercooler 138, the coolant is transferred to the second heat pump 137 where it is again superheated to a temperature of 318.02° C., corresponding to a temperature “lift” of 73.02° C. The pressure ratio across the heat pump 137 is assumed to be 1.714. The power consumed by the heat pump 137 is 46.9 kW, assuming mechanical and electrical efficiencies of 85% and 95%, respectively.

From the heat pump 137, the coolant is channeled to the pre-reactor coolant-LOHC_{Rich} heat exchanger 160 to preheat the LOHC_{Rich} to its final dehydrogenation temperature of 250° C. The net heat transfer within the pre-reactor coolant-LOHC_{Rich} heat exchanger 160 is 17.66 kW. In the process, the temperature of the coolant decreases from 318.02° C. to 302.2° C. with 26.615° C. of superheat. The coolant is then routed to a pre-reactor coolant-hydrogen heat exchanger 169, where it preheats the hydrogen generated during the dehydrogenation process. The net heat transfer within the pre-reactor coolant-hydrogen heat exchanger 160 is 28.11 kW. After preheating the hydrogen, the coolant, with a superheat of 5.015° C., is transferred to the dehydrogenation reactor 180. Within the dehydrogenation reactor 180, while supplying endothermic heat of dehydrogenation of 512.25 kA, the coolant progressively transitions from superheated vapor to saturated liquid phase. To ensure proper heat transfer between the LOHC_{Rich} and the coolant, a temperature difference of 25.585° C. is maintained within the dehydrogenation reactor 180. The coolant leaving the dehydrogenation reactor 180 is then routed to the secondary radiator 117 where it exchanges heat with the surrounding environment, with ambient air acting as the final heat sink. The net heat dissipation from the secondary radiator 117 into the ambient air is 102.4 kW. During this, the temperature of the coolant reduces from 275.585° C. to 210.73° C. and its phase changes from saturated liquid to supercooled liquid with 64.86° C. of supercooling. The coolant is passed through expander 134 and returned to the first coolant-second coolant heat exchanger 194.

The dehydrogenation of hydrogen rich methylcyclohexane (the LOHC_{Rich}) is a two-step process: preheating followed by dehydrogenation. The liquid LOHC_{Rich} at 25° C., is first partially preheated to a temperature of 219.25° C. in the LOHC_{Rich}-LOHC_{Lean} heat exchanger 170 using the hot reaction products exiting the dehydrogenation reactor 180, and optionally with electric heater 172. The net heat transfer within the LOHC_{Rich}-LOHC_{Lean} heat exchanger 170 is 183.86 kW. As heat is transferred to the methylcyclohexane (boiling point 100.85° C.) within the LOHC_{Rich}-LOHC_{Lean} heat exchanger 170, it undergoes phase change and exits in a gaseous phase while the dehydrogenation products constituting of a mixture of gaseous methylcyclohexane, toluene (boiling point 110.65° C.), and hydrogen cools down. As the dehydrogenation products cool down, methylcyclohexane and toluene returns to the liquid phase and exits the heat exchanger as a mixture of liquid methylcyclohexane and toluene, and gaseous hydrogen at 80° C. The gaseous hydrogen is then separated in the separator 112, purified in the purifier 118, and routed through the coolant-hydrogen heat exchanger 169 to preheat it to the operating temperature of the fuel cell (240° C.). The net heat transfer within the coolant-hydrogen heat exchanger is 28.11 kW. The liquid constituents, containing a mixture of methylcyclohexane, and toluene are discharged into the LOHC_{Lean} return 159. From the LOHC_{Rich}-LOHC_{Lean} heat exchanger 170, methylcyclohexane is routed to the pre-reactor coolant-LOHC_{Rich} heat exchanger 160 where it is preheated to its final dehydrogenation temperature of 250° C. and then sent to the dehydrogenation reactor 180. The net heat transfer within the pre-reactor coolant-LOHC_{Rich} heat exchanger 160 is 17.66 kW. In the dehydrogenation reactor 180, methylcyclohexane is dehydrogenated in the presence of a catalyst.

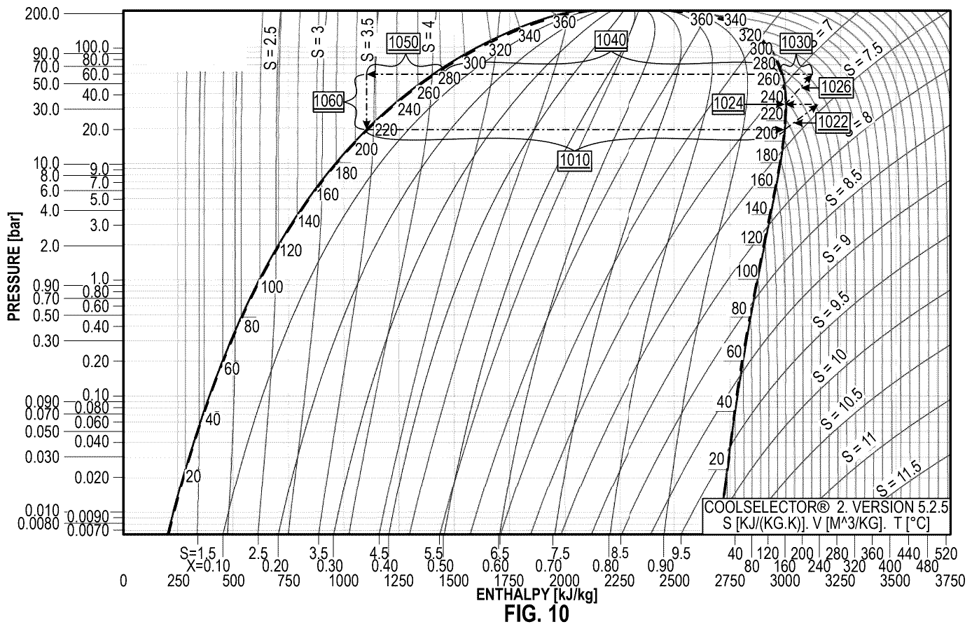

FIG. 10 provides a thermodynamic cycle diagram of the second coolant portion of the coolant circuit 120 of the system illustrated in FIG. 9. The fuel cell cooling branch 1010 represents the process of a second coolant accepting heat from a first coolant at a first coolant-second coolant heat exchanger 194. The first coolant provides heat obtained from a fuel cell 101 via a coolant-fuel cell heat exchanger 107. The second coolant leaves the first coolant-second coolant heat exchanger 194 and passes through a temperature lift stage 130 which includes multiple heat pumps and with an intervening intercooler. The heat pump branch 1020 (represented by superheating step 1022, intermediate cooling step 1024, superheating step 1026) represents a sequential, stepwise compression superheating process that serves to efficiently heat the vaporized coolant. The use of a first heat pump 135 provides a superheating step 1022, followed by an intercooler 138 that provides an intermediate cooling step 1024, followed by an additional heat pump 137 that provides a superheating step 1026, facilitates use of cost-effective and readily-available heat pumps to provide a significant lift. The superheated coolant is then passed through a heat exchanger at high temperature that interfaces the coolant circuit with the LOHC system 150 at high temperature. The high temperature heat exchanger branch 1030 represents transfer of sensible heat from the coolant to the LOHC_{Rich} in the LOHC pre-heating stage 155. Here, the vapor phase can be maintained. Then, the vapor phase coolant is provided to a heat exchanger in the dehydrogenation reactor 180. The dehydrogenation branch 1040 represents the coolant-reactor heat exchanger 185, where the coolant dissipates its heat to facilitate the endothermic dehydrogenation process and in the processes condenses and delivers the latent heat captured from the fuel cell. After the dehydrogenation reactor 180, the coolant can be transmitted to a secondary radiator 117 to facilitate heat dissipation which can represent an efficient means of heat dissipation with respect to the system overall. The secondary radiator branch 1050 represents the isobaric heat dissipation of the secondary radiator 117. Lastly, the coolant is delivered to an expander 134 and then sent returned to the first coolant-second coolant heat exchanger 194. The expansion branch 1060 represents the expansion that completes the cycle.

FIG. 16 provides a schematic of a fuel cell system 100 in a sixth example, which involves a coolant circuit 120 having a single coolant loop, a temperature lift stage 130, a coolant-hydrogen heat exchanger 169, and a LOHC system 150 having a pre-heating stage 155 with a heat exchanger utilizing heat from coolant at the temperature lift stage upstream of the dehydrogenation reactor 180.

The fuel cell system 100 includes a fuel cell stack 102, an anode 103, and a cathode 104. The fuel cell 101 utilizes hydrogen obtained from a hydrogen supply line 110 and an oxidant obtained from an oxidant supply system 105. The oxidant supply system 105 provides oxidant to the fuel cell 101 via an oxidant supply line 106. The operation of the fuel cell 101 generates electricity and thermal energy. The fuel cell 101 is cooled by the coolant circuit 120, which interfaces with the fuel cell 101 through a coolant-fuel cell heat exchanger 107. The coolant-fuel cell heat exchanger 107 transfers excess thermal energy generated by the fuel cell 101 via vaporization of the supplied coolant. The coolant circuit 120 utilizes one or more coolants, which can be optionally configured in one or more coolant loops, to capture latent heat from the fuel cell 101 and deliver the latent heat to the dehydrogenation reactor 180 of the LOHC system 150. In various aspects, the coolant is water. The coolant circuit 120 provides coolant to the fuel cell 101 via a coolant supply line 122. The coolant can be optionally heated via a coolant supply electric heater 124 to warm the coolant prior to delivery to the fuel cell 101. At the fuel cell, the coolant passes through a coolant-fuel cell heat exchanger 107 to absorb thermal waste, vaporizing to provide a vapor phase coolant that is transferred away from the fuel cell 101 toward the dehydrogenation reactor 180 via a coolant return line 126. The coolant circuit 120 includes a temperature lift stage 130. As vapor phase coolant travels from the fuel cell 101 to the dehydrogenation reactor 180, the vapor phase coolant is passed through a temperature lift stage 130, which includes a heat pump 135. The heat pump 135 heats the vapor phase coolant which is then transmitted to a pre-reactor coolant-LOHC_{Rich} heat exchanger 160. The pre-reactor coolant-LOHC_{Rich} heat exchanger 160 transfers heat away from the heated coolant to the LOHC_{Rich} ahead of the dehydrogenation reactor 180. This heat exchange can be performed so that the coolant maintains its latent heat but transfers its sensible heat. The coolant is then transferred to a pre-reactor coolant-hydrogen heat exchanger 169. The LOHC is transferred via the LOHC_{Rich} reactor inlet 156 to the dehydrogenation reactor 180. The pre-reactor coolant-hydrogen heat exchanger 169, which operates at a high temperature near that of the dehydrogenation reactor, raises hydrogen to a target temperature for use in the fuel cell 101, while permitting the second coolant to remain in the vapor phase at the target temperature when subsequently transferred to the dehydrogenation reactor 180. The dehydrogenation reactor 180 includes a coolant-reactor heat exchanger 185, which transfers heat from the coolant to the LOHC reaction mixture to facilitate dehydrogenation, which may optionally utilize a electric heater 182. The coolant undergoes phase change at the coolant-reactor heat exchanger 185 to transfer latent heat to the dehydrogenation reactor 180. The coolant is then conveyed away from the dehydrogenation reactor 180 for further heat dissipation at a secondary radiator 117. After the secondary radiator 117, the coolant is sent to an expander 134 and then collected for reuse in the coolant circuit 120. The coolant is provided to a mixer 136. The coolant circuit 120 also dissipates heat from the fuel cell 101 at a primary radiator 116. The coolant circuit is configured with configurable diversions via a flow diverter 129 to provide primary radiator dissipation, which can optionally utilize one or more functional valve 133, which can provide a control function. The flow diverter 129 can control how much heated coolant is sent to the dehydrogenation reactor 180 and how much is sent to the primary radiator 116. The coolant from the primary radiator 116 is provided to the mixer 136. The mixer 136 collects and combines the coolant, which can be substantially liquid, and provides it to the coolant reservoir 139 which serves as a coolant supply. The supply coolant is provided to the fuel cell 101 via the coolant supply line 122, which can include a coolant supply pump 123 or coolant supply electric heater 124. A direct supply valve 149 can be located between the mixer 136 and the coolant reservoir 139. When activated, the direct supply valve 149 can provide returned coolant directly to the fuel cell 101, which can be useful after the system is started when the supply line electric heater 124 is not being utilized. The LOHC system 150 includes a dehydrogenation reactor 180 that receives LOHC_{Rich} via a LOHC_{Rich} supply line 152, which utilizes one or more LOHC supply pumps 153 to convey LOHC from a LOHC_{Rich} supply 151 to an LOHC_{Lean} return 159. The dehydrogenation reactor 180 extracts hydrogen from the LOHC_{Rich}, resulting in a mixture of hydrogen and LOHC_{Lean}. The mixture of hydrogen and LOHC_{Lean}, which is warm from the reactor, is sent to a LOHC_{Rich}-LOHC_{Lean} heat exchanger 170, to provide further pre-heating of the LOHC_{Rich} prior to its arrival at the subsequent coolant-LOHC heat exchangers. After the LOHC_{Rich}-LOHC_{Lean} heat exchanger 170, the mixture of hydrogen and LOHC_{Lean} is then sent through a LOHC_{Lean} outlet 157 to a hydrogen separator 112 to isolate hydrogen from the LOHC_{Lean}. The separated hydrogen is processed through a purifier 118, and then passed through a pre-reactor coolant-hydrogen heat exchanger 169 to heat up the hydrogen before being delivered to the fuel cell 101 via hydrogen supply line 110, which can include a purifier 118 en route. The separated LOHC_{Lean} is removed via a LOHC_{Lean} return line 158 which delivers the LOHC_{Lean} to a LOHC_{Lean} return 159 for storage in a reservoir or sent for rehydrogenation for regeneration of the LOHC_{Rich}. The LOHC system 150 includes a LOHC pre-heating stage 155 where the LOHC_{Rich} is heated prior to entering the dehydrogenation reactor 180. The LOHC pre-heating stage 155 illustrated here includes the high-temperature coolant-LOHC heat exchanger 160.

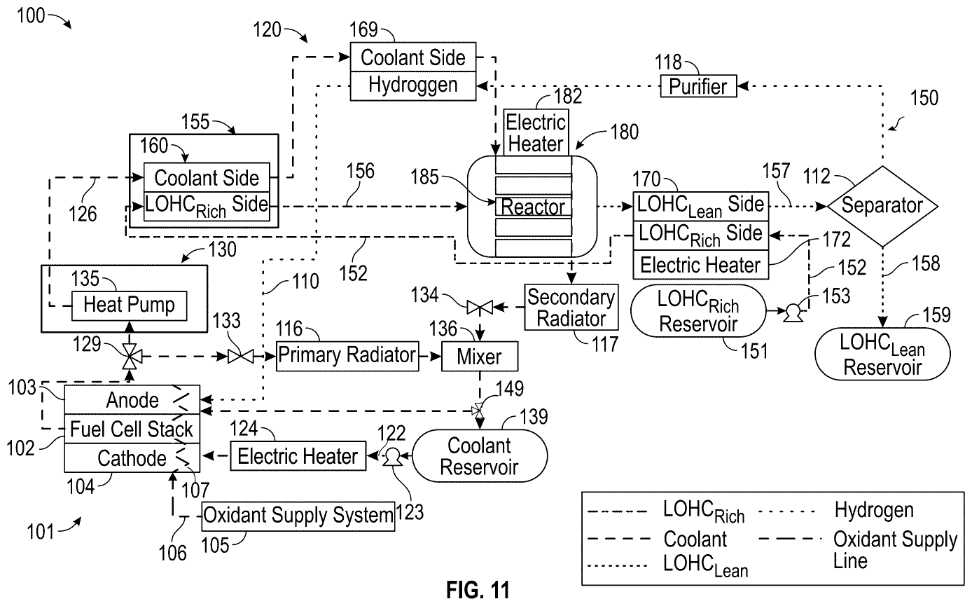

An example system (Example 6) was modeled based on a system architecture according to FIG. 11, using methylcyclohexane/toluene as a LOHC rich-lean pair. The modeled operation of the fuel cell power system, involves several assumptions and simplifications. The fuel cell power system incorporates one or more fuel cell stacks with a gross power output of 625.0 kW. It is assumed that the fuel cell stack has an overall efficiency of approximately 50% and operates at an average temperature of 240° C., 10° C. below the dehydrogenation temperature of 250° C. Furthermore, no pressure drop within the coolant system has been considered. The efficiency of the dehydrogenation reaction is assumed to be 80%.

In Example 6, a fuel cell 101 operating at a temperature of 240° C. incorporates a coolant circuit 120 that employes refrigerant R718 (water) as the coolant. The cooling of the fuel cell follows the “cooling through boiling” principle. The coolant enters the fuel cell 101 as wet vapor at a temperature and pressure of 242.557° C. and 35 bar, respectively, with 0.0734 quality. As the heat generated by the fuel cell 101 is transferred to the coolant, it gradually undergoes phase change before leaving the fuel cell 101 as superheated vapor at 245.0° C. with 2.443° C. of superheat. The net heat transferred to the coolant in the fuel cell 101 is 627.24 kW. After leaving the fuel cell 101, a portion of the coolant is transferred to the heat pump 135 where it is further superheated to a temperature of 318.02° C., corresponding to a temperature “lift” of 73.02° C. The pressure ratio across the heat pump is assumed to be 1.714. The power consumed by the heat pump 135 is 46.53 kW, assuming mechanical and electrical efficiencies of 85% and 95%, respectively. The remaining portion of the coolant is redirected to the primary radiator 116 (air-cooled) where it exchanges heat with the environment, with the ambient air acting as the final heat sink. The net heat dissipation from the primary radiator 116 into the ambient air is 94.68 kW. From the heat pump 135, the coolant is channeled to the pre-reactor coolant-LOHC_{Rich} heat exchanger 160 to preheat the LOHC_{Rich} to its final dehydrogenation temperature of the 250° C. The net heat transfer within the pre-reactor coolant-LOHC_{Rich} heat exchanger 160 is 17.66 kW. In the process, the temperature of the coolant decreases from 318.02° C. to 302.11° C. with 26.525° C. of superheat. The coolant is then routed to the pre-reactor coolant-hydrogen heat exchanger 169 where it preheats the hydrogen generated during the dehydrogenation process. The net heat transfer within the coolant-hydrogen heat exchanger is 28.11 kW. After preheating the hydrogen, the coolant, with a superheat of 5.015° C., is transferred to the dehydrogenation reactor 180. Within the dehydrogenation reactor 180, while supplying endothermic heat of dehydrogenation of 512.25 kW, the coolant progressively transitions from superheated vapor to saturated liquid phase. To ensure proper heat transfer between LOHC_{Rich} and the coolant, a temperature difference of 25.585° C. is maintained within the dehydrogenation reactor 180. The coolant leaving the dehydrogenation reactor 180 is then sent to the secondary radiator 117 where it exchanges heat with the surrounding environment, with ambient air acting as the final heat sink. The net heat dissipation from the secondary radiator 117 into the ambient air is 9.4 kW. In the process, the temperature of the coolant reduces from 275.585° C. to 270.0° C. and its phase changes from saturated liquid to supercooled liquid with 5.585° C. of supercooling. The supercooled coolant is then expanded and transferred to a mixer 136 where it merges with the coolant stream returning from the primary radiator before it is returned to the fuel cell 101.

The dehydrogenation of hydrogen rich methylcyclohexane (the LOHC_{Rich}) is a two-step process: preheating followed by dehydrogenation. The liquid LOHC_{Rich} at 25° C., is first partially preheated to a temperature of 219.25° C. in the LOHC_{Rich}-LOHC_{Lean} heat exchanger 170 using the hot reaction products exiting the dehydrogenation reactor, and optionally electric heater 172. The net heat transfer within the LOHC_{Rich}-LOHC_{Lean} heat exchanger 170 is 183.86 kW. As heat is transferred to the methylcyclohexane (boiling point 100.85° C.) within the LOHC_{Rich}-LOHC_{Lean} heat exchanger 170, it undergoes phase change and exits the heat exchanger in a gaseous phase while the dehydrogenation products constituting of a mixture of gaseous methylcyclohexane, toluene (boiling point 110.65° C.), and hydrogen cools down. As the dehydrogenation products cools down, methylcyclohexane and toluene returns to the liquid phase and exits the LOHC_{Rich}-LOHC_{Lean} heat exchanger 170 as a mixture of liquid methylcyclohexane and toluene, and gaseous hydrogen at 80° C. The gaseous hydrogen is then separated from the liquid mixture in the separator 112, purified in the purifier 118, and routed through the pre-reactor coolant-hydrogen heat exchanger 169 to preheat it to the operating temperature of the fuel cell (240° C.). The liquid constituents, containing a mixture of methylcyclohexane, and toluene are discharged into the LOHC_{Lean} return 159. From the LOHC_{Rich}-LOHC_{Lean} heat exchanger 170, methylcyclohexane is routed to the pre-reactor coolant-LOHC_{Rich} heat exchanger 160 where it is further heated to its final dehydrogenation temperature of 250° C. and then sent to the dehydrogenation reactor 180. The net heat transfer within the pre-reactor coolant-LOHC_{Rich} heat exchanger 160 is 17.66 kW. In the dehydrogenation reactor 180, methylcyclohexane is dehydrogenated in the presence of a catalyst.

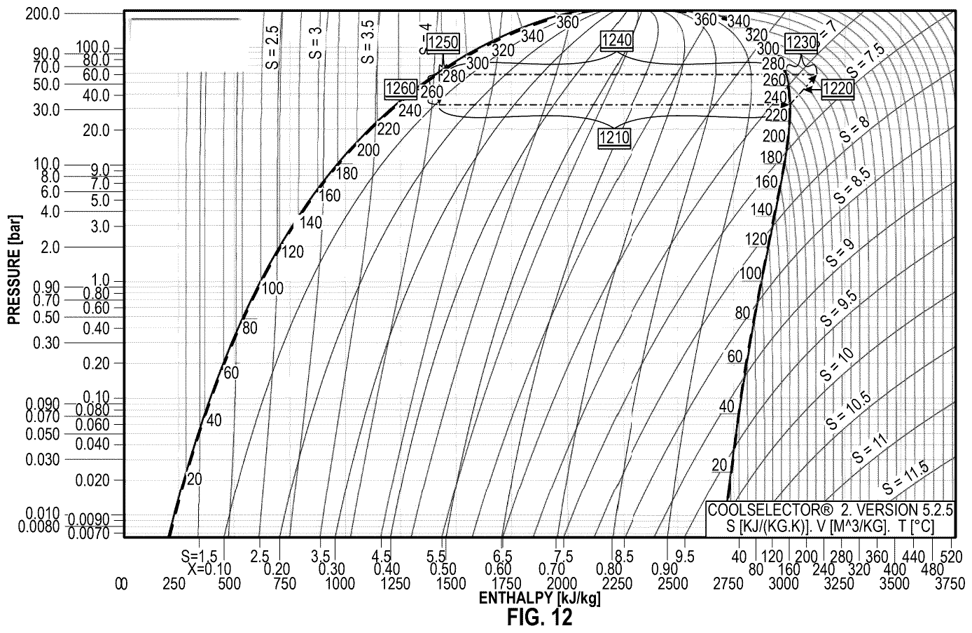

FIG. 12 provides a thermodynamic cycle diagram of the portion of the coolant circuit 120 of the system illustrated in FIG. 11 that transfers heat from the fuel cell 101 to the dehydrogenation reactor 180 and circulates the coolant back to the fuel cell 101. The fuel cell cooling branch 1210 represents the process of coolant accepting heat from the fuel cell 101 at a coolant-fuel cell heat exchanger 107, which results in phase change of the coolant from liquid coolant to vapor coolant. The coolant leaves the fuel cell 101 and passed through a temperature lift stage 130 which includes a heat pump 135. The heat pump branch 1220 represents compression superheating process of heat pump 135 that serves to efficiently heat the vaporized coolant. The superheated coolant is then passed through a heat exchanger that interfaces the coolant circuit 120 with the LOHC system 150 at high temperature, i.e., the pre-reactor coolant-LOHC_{Rich} heat exchanger 160. The high temperature heat exchanger branch 1230 represents transfer of sensible heat from the coolant to the LOHC_{Rich} in the LOHC pre-heating stage 155. Here, the vapor phase can be maintained. Then, the vapor phase coolant is provided to a heat exchanger in the dehydrogenation reactor 180. The dehydrogenation branch 1240 represents the coolant-reactor heat exchanger 185, where the coolant dissipates its heat to facilitate the endothermic dehydrogenation process and in the processes condenses and delivers the latent heat captured from the fuel cell 101. After the dehydrogenation reactor 180, the coolant can be transmitted to a secondary radiator 117 to facilitate heat dissipation which can represent an efficient means of heat dissipation with respect to the system overall. The secondary radiator branch 1250 represents the isobaric heat dissipation of the secondary radiator 117. Lastly, the coolant is delivered to an expander 134 and then subsequently collected for recirculation to the fuel cell 101. The expansion branch 1260 represents the expansion that completes the cycle.

The systems of Examples 1-6 were further modeled with electric heater start up conditions. There was assumed to be no pressure-drop within the system. The example systems were provided with three or more electric heaters, e.g., electric heater 124, electric heater 172, and electric heater 182; which corresponds to one within the coolant supply line 122 and the others with the LOHC_{Rich}-LOHC_{Lean} heat exchanger 170 and the dehydrogenation reactor 180. During startup, the electric heater 124 in the coolant supply line 122 heats up the coolant, which in turn gradually heats up the fuel cell 101 and other equipment installed in the system to its operating temperature. Once the equipment in the coolant circuit 120 have reached the steady-state operating temperature, the electric heater 172 at the LOHC_{Rich}-LOHC_{Lean} heat exchanger 170 is powered on to provide additional heat to preheat the LOHC_{Rich} to its dehydrogenation temperature. As the LOHC_{Rich} flows through the dehydrogenation reactor 180, the coolant, augmented by the reactor electric heater 182, provides heat for endothermic dehydrogenation reaction. Hydrogen supplied to the fuel cell 101 from the dehydrogenation reactor 180 during start-up can be optionally augmented by a separate on-board hydrogen storage system (e.g., compressed gaseous hydrogen tank). Then in the course of operation, a part of the hydrogen released from the LOHC_{Rich} can be used to replenish the tank. Once steady state operation is reached, all the three heaters are switched off.

Example 1-6 describe fuel cell systems that integrate a LOHC system 150 with a high or intermediate temperature PEM-FCPS using hydrogen as fuel for power generation. These results suggest that such systems can be suitable for on-board power generation, such as in future electric Part 23 and 25 aircraft and UAMs. One of the obstacles to on-board power generation with PEM-FCPS is the size of the radiators that are often used to reject the poor-quality heat generated by the fuel cell 101 during its operation. However, these results show that by integrating a LOHC system 150 with the coolant circuit 120 of a fuel cell 101, even in the case of a PEM-FCPS the low-quality heat generated by the fuel cell 101 can be re-used to provide heat for dehydrogenation. Since dehydrogenation is an endothermic reaction, waste heat supplied is consumed within the system. As a result, the configurations described herein result in a significant reduction in the amount of heat to be rejected to the environment. Indeed, these results show it is possible to reduce the size of the radiators by up to approximately 60-80% based on the presently described system configurations and selections.

TABLE 1

| | | | | | | |
|---|---|---|---|---|---|---|
| System | | | | | | |
| Parameter | Ex. 1 | Ex. 2 | Ex. 3 | Ex. 4 | Ex. 5 | Ex. 6 |

Heat Generated by the High or Intermediate Temperature PEMFCPS

| | | | | | | |
|---|---|---|---|---|---|---|
| Heat Generated | 624.25 | 624.25 | 623.23 | 623.23 | 627.24 | 627.24 |
| (kW) | | | | | | |

Heat Rejected from the Radiator(s)/Intercooler

| | | | | | | |
|---|---|---|---|---|---|---|
| Primary | 244.69 | 212.66 | 242.47 | 243.85 | 0.0 | 94.68 |
| Radiator (kW) | | | | | | |
| Secondary | — | 33.62 | 11.0 | — | 102.4 | 9.4 |
| Radiator (kW) | | | | | | |
| Intercooler | — | — | — | 24.5 | 44.61 | — |
| (kW) | | | | | | |
| Total (kW) | 244.69 | 246.28 | 253.47 | 268.35 | 147.01 | 104.08 |

The described systems involve use of one or more heat pump within the coolant line to provide a temperature gradient between coolant and the LOHC_{Rich}. This does put a penalty on the overall efficiency of the PEM-FCPS, but the parasitic power consumption is still less than about 20%, and it is typically limited to 7.5-12.5% of the net power. Surprisingly, such configuration nonetheless provides a significantly advantageous result overall. Without re-use of the waste heat from the fuel cell, the electric power to supply just the endothermic heat of dehydrogenation would be at least 75-105% of the net power produced by the fuel cell assuming no losses.

TABLE 2

| System | | | | | | |
|---|---|---|---|---|---|---|
| Parameter | Ex. 1 | Ex. 2 | Ex. 3 | Ex. 4 | Ex. 5 | Ex. 6 |
| Gross Power | 625.0 | 625.0 | 625.0 | 625.0 | 625.0 | 625.0 |
| (kW) | | | | | | |
| BOP Parasitic | 125.0 | 125.0 | 125.0 | 125.0 | 125.0 | 125.0 |
| Power (kW) | | | | | | |
| Net Power (kW) | 500.0 | 500.0 | 500.0 | 500.0 | 500.0 | 500.0 |

Additional Parasitic Power Consumption Within
Dehydrogenation Circuit—Example Concepts

| | | | | | | |
|---|---|---|---|---|---|---|
| Heat Pump (kW) | 36.9 | 36.9 | 62.92 | 62.92 | 95.63 | 46.53 |

Additional Parasitic Power Consumption Within
Dehydrogenation Circuit—Only Electric Heaters

| | | | | | | |
|---|---|---|---|---|---|---|
| Electric Power | 379.5 | 379.5 | 379.5 | 379.5 | 512.25 | 512.25 |
| (kW) | | | | | | |

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Modifications, selections, and variations of the concepts described herein by those of ordinary skill are considered to be within the scope of aspects of the present disclosure.

### Exemplary Aspects

The following exemplary aspects are provided, the numbering of which is not to be construed as designating levels of importance:

Aspect 1 provides a system comprising:
a fuel cell and a dehydrogenation reactor, wherein the fuel cell has an operating temperature about, or less than, an operating temperature of the dehydrogenation reactor;
a coolant circuit configured to circulate a coolant from a heat-exchanger of the fuel cell through a temperature lift stage to a heat-exchanger of the dehydrogenation reactor;
a LOHC line configured to transfer a LOHC from a hydrogen-rich LOHC (LOHC_{Rich}) supply through a LOHC pre-heating stage to the dehydrogenation reactor; and
wherein the temperature lift stage comprises a heat pump configured to raise the temperature of the coolant, and a heat exchanger configured to transfer heat from the coolant in the temperature lift stage to the LOHC in the pre-heating stage.

Aspect 2 provides a system of Aspect 1, wherein the coolant circuit is configured to provide latent heat from the fuel cell to the dehydrogenation reactor.

Aspect 3 provides a system of any one of Aspects 1-2, wherein the fuel cell heat exchanger provides the coolant to the temperature lift stage as a vapor phase coolant.

Aspect 4 provides a system of any one of Aspects 1-3, wherein the temperature lift stage is configured to provide sensible heat transfer from the coolant to the LOHC prior to delivery of the LOHC to the dehydrogenation reactor.

Aspect 5 provides a system of any one of Aspects 1-4, wherein the coolant circuit is configured for the coolant to undergo a phase change from liquid phase to vapor phase at the heat exchanger of the fuel cell, and to undergo a phase change from vapor phase to liquid phase at the heat exchanger of the dehydrogenation reactor.

Aspect 6 provides a system of any one of Aspects 1-5, wherein the coolant circuit is configured to maintain the coolant in a vapor phase from the heat-exchanger of the fuel cell through the temperature lift stage to the heat-exchanger of the dehydrogenation reactor.

Aspect 7 provides a system of any one of Aspects 1-6, wherein the coolant comprises water.

Aspect 8 provides a system of any one of Aspects 1-7, wherein the LOHC is an dodecahydro-N-ethylcarbazole/N-ethylcarbazole LOHC pair.

Aspect 9 provides a system of any one of Aspects 1-8, wherein the LOHC is methylcyclohexane/toluene LOHC pair.

Aspect 10 provides a system of any one of Aspects 1-9, wherein the fuel cell is a polymer electrolyte membrane fuel cell.

Aspect 11 provides a system of any one of Aspects 1-10, wherein the fuel cell is not a solid-oxide fuel cell.

Aspect 12 provides a system of any one of Aspects 1-11, wherein the operating temperature of the fuel cell is less than 350° C.

Aspect 13 provides a system of any one of Aspects 1-12, wherein the operating temperature of the fuel cell is about 240° C. or less.

Aspect 14 provides a system of any one of Aspects 1-13, wherein the operating temperature of the fuel cell is about 180° C. or less.

Aspect 15 provides a system of any one of Aspects 1-14, wherein the operating temperature of the fuel cell is about 160° C. to about 180° C.

Aspect 16 provides a system of any one of Aspects 1-15, wherein the operating temperature of the dehydrogenation reactor is less than about 450° C.

Aspect 17 provides a system of any one of Aspects 1-16, wherein the operating temperature of the dehydrogenation reactor is about 250° C. or less.

Aspect 18 provides a system of any one of Aspects 1-17, wherein the operating temperature of the dehydrogenation reactor is about 180° C. or less.

Aspect 19 provides a system of any one of Aspects 1-18, wherein the temperature lift stage comprises two or more heat pumps.

Aspect 20 provides a system of any one of Aspects 1-19, wherein the temperature lift stage raises a temperature of the coolant to above the operating temperature of the dehydrogenation reactor.

Aspect 21 provides a system of any one of Aspects 1-20, wherein the temperature lift stage raises a temperature of the coolant by about 25° C. to about 35° C. above the operating temperature of the dehydrogenation reactor.

Aspect 22 provides a system of any one of Aspects 1-21, wherein the temperature lift stage comprises superheating the coolant.

Aspect 23 provides a system of any one of Aspects 1-22, wherein the temperature lift stage maintains the coolant in a vapor phase while transferring heat from the coolant to the LOHC.

Aspect 24 provides a system of any one of Aspects 1-23, wherein the temperature lift stage provides the coolant in a vapor phase to the heat exchanger of the dehydrogenation reactor.

Aspect 25 provides a system of any one of Aspects 1-24, wherein the coolant circuit circulates the coolant from the heat-exchanger of the fuel cell through the temperature lift stage to the heat-exchanger of the dehydrogenation reactor, and from the heat-exchanger of the dehydrogenation reactor through a cooling stage to the heat-exchanger of the fuel cell.

Aspect 26 provides a system of any one of Aspects 1-25, wherein the coolant circuit transfers the LOHC from the LOHC_{Rich} supply through the LOHC pre-heating stage to the dehydrogenation reactor, from the dehydrogenation reactor to a hydrogen separator, and from the hydrogen separator to a hydrogen-lean LOHC return.

Aspect 27 provides a system of Aspect 26, comprising a hydrogen line configured to transfer hydrogen from a hydrogen separator to the fuel cell;

Aspect 28 provides a system of any one of Aspects 1-27, configured as a source of secondary power or propulsive power for a vehicle.

Aspect 29 provides a system of Aspect 28, wherein the vehicle is an aircraft.

Aspect 30 provides a fuel cell system with a coolant circuit integrated with a liquid organic hydrogen carrier (LOHC) system to provide latent heat from a fuel cell to a dehydrogenation reactor, the fuel cell system comprising:
one or more heat pumps that receive a vapor phase coolant from a fuel cell operating about or below a operating temperature of the dehydrogenation reactor, and superheat the vapor phase coolant to above the operating temperature of the dehydrogenation reactor, and
a heat exchanger that transfers sensible heat from the superheated vapor phase coolant to a LOHC_{Rich}.

Aspect 31 provides a system of Aspects 30, wherein the coolant circuit is configured to provide latent heat from the fuel cell to the dehydrogenation reactor.

Aspect 32 provides a system of any one of Aspects 30-31, wherein the fuel cell comprises a fuel cell heat exchanger that transfers heat away from the fuel cell and vaporizes liquid phase coolant prior to transferring it away from the fuel cell to a temperature lift stage where the vapor phase coolant is superheated.

Aspect 33 provides a system of any one of Aspects 30-32, wherein the heat exchanger that transfers sensible heat from the superheated vapor phase coolant to a LOHC_{Rich} is configured so the sensible heat transfer occurs prior to the LOHC_{Rich} arriving at the dehydrogenation reactor.

Aspect 34 provides a system of any one of Aspects 30-33, wherein the coolant circuit is configured for the coolant to undergo a phase change from liquid phase to vapor phase at a heat exchanger of the fuel cell, and to undergo a phase change from vapor phase to liquid phase at a heat exchanger of the dehydrogenation reactor.

Aspect 35 provides a system of any one of Aspects 30-34, wherein the coolant circuit is configured to maintain the coolant in a vapor phase from a heat-exchanger of the fuel cell through a superheating stage to a heat-exchanger of the dehydrogenation reactor.

Aspect 36 provides a system of any one of Aspects 30-35, wherein the coolant comprises water.

Aspect 37 provides a system of any one of Aspects 30-36, wherein the LOHC is an dodecahydro-N-ethylcarbazole/N-ethylcarbazole LOHC pair.

Aspect 38 provides a system of any one of Aspects 30-37, wherein the LOHC is methylcyclohexane/toluene LOHC pair.

Aspect 39 provides a system of any one of Aspects 30-38, wherein the fuel cell is a polymer electrolyte membrane fuel cell.

Aspect 40 provides a system of any one of Aspects 30-39, wherein the fuel cell is not a solid-oxide fuel cell.

Aspect 41 provides a system of any one of Aspects 30-40, wherein the operating temperature of the fuel cell is less than 350° C.

Aspect 42 provides a system of any one of Aspects 30-41, wherein the operating temperature of the fuel cell is about 240° C. or less.

Aspect 43 provides a system of any one of Aspects 30-42, wherein the operating temperature of the fuel cell is about 180° C. or less.

Aspect 44 provides a system of any one of Aspects 30-43, wherein the operating temperature of the fuel cell is about 160° C. to about 180° C.

Aspect 45 provides a system of any one of Aspects 30-44, wherein the operating temperature of the dehydrogenation reactor is less than about 450° C.

Aspect 46 provides a system of any one of Aspects 30-45, wherein the operating temperature of the dehydrogenation reactor is about 250° C. or less.

Aspect 47 provides a system of any one of Aspects 30-46, wherein the operating temperature of the dehydrogenation reactor is about 180° C. or less.

Aspect 48 provides a system of any one of Aspects 30-47, wherein which comprises two or more heat pumps configured to superheat the vapor phase coolant and transfer sensible heat to the LOHC_{Rich}.

Aspect 49 provides a system of any one of Aspects 30-48, wherein superheating comprises raising a temperature of the coolant to above the operating temperature of the dehydrogenation reactor.

Aspect 50 provides a system of any one of Aspects 30-49, wherein superheating comprises raises a temperature of the coolant by about 25° C. to about 35° C. above the operating temperature of the dehydrogenation reactor.

Aspect 51 provides a system of any one of Aspects 30-50, which comprises superheating the vapor phase coolant two or more times.

Aspect 52 provides a system of any one of Aspects 30-51, which maintains the coolant in a vapor phase while transferring heat from the coolant to the LOHC_{Rich}.

Aspect 53 provides a system of any one of Aspects 30-52, which provides the coolant in a vapor phase to the heat exchanger of the dehydrogenation reactor.

Aspect 54 provides a system of any one of Aspects 30-53, wherein the coolant circuit circulates the coolant from a heat-exchanger of the fuel cell through the one or more heat pump to a heat-exchanger of the dehydrogenation reactor, and from the heat-exchanger of the dehydrogenation reactor through a cooling stage to the heat-exchanger of the fuel cell.

Aspect 55 provides a system of any one of Aspects 30-54, wherein the coolant circuit transfers a LOHC_{Rich} from a supply through the sensible heat exchanger to the dehydrogenation reactor, from the dehydrogenation reactor to a hydrogen separator, and from the hydrogen separator to a hydrogen-lean LOHC return.

Aspect 56 provides a system of Aspect 55, comprising a hydrogen line configured to transfer hydrogen from the hydrogen separator to the fuel cell.

Aspect 57 provides a system of any one of Aspects 30-56, configured as a source of secondary power or propulsive power for a vehicle.

Aspect 58 provides a system of Aspect 57, wherein the vehicle is an aircraft.

Aspect 59 provides the system of any one or any combination of Aspect 1-58 optionally configured for aerospace use, aviation use, or spaceflight use; configured for use upon an aircraft or spacecraft; or configured for use during flight.

Aspect 60 provides the system of any one or any combination of Aspect 1-59 optionally configured such that all elements or options recited hereinabove are available to use or select from.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present disclosure. Thus, it should be understood that although the present disclosure includes an enumeration of specific aspects and optional features, modification and variation of the concepts herein disclosed may be resorted to by those of ordinary skill in the art, and that such modifications and variations are considered to be within the scope of the disclosure.

What is claimed is:

1. A system comprising:
a fuel cell and a dehydrogenation reactor, wherein the fuel cell has an operating temperature about, or less than, an operating temperature of the dehydrogenation reactor;
a coolant circuit configured to circulate a coolant from a heat-exchanger of the fuel cell through a temperature lift stage to a heat-exchanger of the dehydrogenation reactor; and
a liquid organic hydrogen carrier (LOHC) line configured to transfer a LOHC from a hydrogen-rich LOHC (LOHC_{Rich}) supply through a LOHC pre-heating stage to the dehydrogenation reactor;
wherein the temperature lift stage comprises a heat pump configured to raise the temperature of the coolant, and a heat exchanger configured to transfer heat from the coolant in the temperature lift stage to the LOHC in the pre-heating stage.

2. The system of claim 1, wherein the coolant circuit is configured to provide latent heat from the fuel cell to the dehydrogenation reactor.

3. The system of claim 1, wherein the fuel cell heat exchanger provides the coolant to the temperature lift stage as a vapor phase coolant.

4. The system of claim 1, wherein the temperature lift stage is configured to provide sensible heat transfer from the coolant to the LOHC prior to delivery of the LOHC to the dehydrogenation reactor.

5. The system of claim 1, wherein the coolant circuit is configured for the coolant to undergo a phase change from liquid phase to vapor phase at the heat exchanger of the fuel cell, and to undergo a phase change from vapor phase to liquid phase at the heat exchanger of the dehydrogenation reactor.

6. The system of claim 1, wherein the coolant circuit is configured to maintain the coolant in a vapor phase from the heat-exchanger of the fuel cell through the temperature lift stage to the heat-exchanger of the dehydrogenation reactor.

7. The system of claim 1, wherein the coolant comprises water.

8. The system of claim 1, wherein the LOHC is an dodecahydro-N-ethylcarbazole/N-ethylcarbazole LOHC pair, or methylcyclohexane/toluene LOHC pair.

9. The system of claim 1, wherein the operating temperature of the fuel cell is less than 350° C.

10. The system of claim 1, wherein the operating temperature of the fuel cell is about 180° C. or less.

11. The system of claim 1, wherein the operating temperature of the dehydrogenation reactor is less than about 450° C.

12. The system of claim 1, wherein the operating temperature of the dehydrogenation reactor is about 180° C. or less.

13. The system of claim 1, wherein the temperature lift stage raises a temperature of the coolant to above the operating temperature of the dehydrogenation reactor.

14. The system of claim 1, wherein the temperature lift stage raises a temperature of the coolant by about 25° C. to about 35° C. above the operating temperature of the dehydrogenation reactor.

15. The system of claim 1, wherein the temperature lift stage comprises superheating the coolant.

16. The system of claim 1, wherein the temperature lift stage maintains the coolant in a vapor phase while transferring heat from the coolant to the LOHC.

17. The system of claim 1, wherein the temperature lift stage provides the coolant in a vapor phase to the heat exchanger of the dehydrogenation reactor.

18. The system of claim 1, configured as a source of secondary power or propulsive power for a vehicle.

19. The system of claim 18, wherein the vehicle is an aircraft.

20. A fuel cell system with a coolant circuit integrated with a liquid organic hydrogen carrier (LOHC) system to provide latent heat from a fuel cell to a dehydrogenation reactor, the fuel cell system comprising:
one or more heat pumps that receive a vapor phase coolant from a fuel cell operating about or below an operating temperature of the dehydrogenation reactor, and superheat the vapor phase coolant to above the operating temperature of the dehydrogenation reactor, and
a heat exchanger that transfers sensible heat from the superheated vapor phase coolant to a hydrogen-rich LOHC (LOHC_{Rich}).
